(19) United States
(12) Patent Application Publication
(10) Pub. No.: US 2008/0254874 A1
(43) Pub. Date: Oct. 16, 2008

(54) GAMING MACHINE ENABLING BET FOR GETTING INSURANCE-PAY AND METHOD OF PLAYING GAMES USING THE SAME

(75) Inventors: Jun Fujimoto, Tokyo (JP); Yukinori Inamura, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/022,686

(22) Filed: Jan. 30, 2008

Related U.S. Application Data
(60) Provisional application No. 60/907,677, filed on Apr. 13, 2007.

(51) Int. Cl. G07F 17/32

(52) U.S. Cl. 463/27

(57) ABSTRACT

A gaming machine includes a display configured to display an image concerning a unit game for determining whether or not a play result deserves a payout, a counter configured to be reset under a predetermined condition and to increment a count value every time the unit game is executed, and a controller. The controller performs control to provide a predetermined amount of payout when a play result of the unit game satisfies a specific play result, to receive a bet, as a prerequisite for getting an insurance-pay, made on an arbitrary number of the unit games set as a group, and to provide a predetermined amount of payout when the count value reaches a predetermined value in the group of the unit games.

### CROSS-REFERENCE TO RELATED APPLICATION

This application is based upon and claims the benefit of U.S. Provisional Application No. 60/907,677, filed on Apr. 13, 2007; the entire contents of which are incorporated herein by reference.

### BACKGROUND OF THE INVENTION

1. Field of the invention

The present invention relates to a gaming machine in which a player can make a bet for getting an insurance-pay and a method of playing games using the gaming machine.

2. Description of the Related Art

Typical gaming machines such as slot machines are disclosed in U.S. Pat. No. 5,820,459, U.S. Pat. No. 6,695,697, US Patent Application Publication No. 2003/0069073, EP Patent Application Publication No. 1192975, U.S. Pat. No. 6,254,483, U.S. Pat. No. 5,611,730, U.S. Pat. No. 5,639,088, U.S. Pat. No. 6,257,981, U.S. Pat. No. 6,234,896, U.S. Pat. No. 6,001,016, U.S. Pat. No. 6,273,820, U.S. Pat. No. 6,224,482, U.S. Pat. No. 4,669,731, U.S. Pat. No. 6,244,957, U.S. Pat. No. 5,910,048, U.S. Pat. No. 5,695,402, U.S. Pat. No. 6,003,013, U.S. Pat. No. 4,283,709, EP Patent Application Publication No. 0631798, German Patent Application Publication No. 4137010, British Patent Application Publication No. 2326830, German Patent Application Publication No. 3712841, U.S. Pat. No. 4,964,638, U.S. Pat. No. 6,089,980, U.S. Pat. No. 5,280,909, U.S. Pat. No. 5,702,303, U.S. Pat. No. 6,270,409, U.S. Pat. No. 5,770,533, U.S. Pat. No. 5,836,817, U.S. Pat. No. 6,932,704, U.S. Pat. No. 6,932,707, U.S. Pat. No. 4,837,728, EP Patent Application Publication No. 1302914, U.S. Pat. No. 4,624,459, U.S. Pat. No. 5,564,700, International Publication WO03/083795, German Patent Application Publication No. 3242890, EP Patent Application Publication No. 0840264, German Patent Application Publication No. 10049444, International Publication WO04/095383, EP Patent Application Publication No. 1544811, U.S. Pat. No. 5,890,963, EP Patent Application Publication No. 1477947, and EP Patent Application Publication No. 1351180.

In a facility equipped with such gaming machines, a player can play a game offered by a gaming machine by making a bet with coins or credits in the gaming machine.

For example, every time a player makes a bet in a slot machine and presses a start switch, the slot machine executes a unit game for rearranging multiple symbols that are arranged on a display. Then, if a combination of the symbols rearranged on the display matches a predetermined winning combination, the slot machine provides a payout corresponding to the winning combination.

Moreover, the slot machine also performs a payout called a jackpot. That is, the slot machine pools part of the bet in this slot machine as a bet for the jackpot. Then, the slot machine determines to payout or not to payout the pooled bets at a predetermined timing. When the slot machine determines the payout, the slot machine provides a payout of the bets pooled for the jackpot to the player.

Incidentally, in the above-described gaming machines, a value calculated by subtracting the amount of bets that the player gets paid out from the gaming machine, from the amount of the bets that the player makes in the gaming machine is equal to an amount of loss of the player. The player becomes more anxious as the amount of loss increases, and may eventually lose interest in the game as a result of this growing anxiety.

The present invention has been made in view of this problem. It is an object of the present invention to provide a gaming machine and a method of playing games using the gaming machine which offers a better entertainment value by relieving anxiety of a player.

### SUMMARY OF THE INVENTION

A first aspect of the present invention provides a method of playing games using a gaming machine configured to execute unit games consecutively, which includes the steps of making a bet on the unit games; providing a predetermined amount of award when a play result of the unit game satisfies a specific play result; making a bet as a prerequisite for getting an insurance-pay on an arbitrary number of the unit games set as a group; incrementing a count value to be reset under a predetermined resetting condition every time the unit game is executed; and providing a predetermined amount of award when the count value reaches a predetermined value in the group of the unit games on which the bet as a prerequisite for getting the insurance-pay is made.

A second aspect of the present invention provides a method of playing games using a gaming machine configured to execute unit games consecutively, which includes the steps of: making a bet on the unit games; providing a predetermined amount of award when a play result of the unit game satisfies a specific play result; making a bet as a prerequisite for getting an insurance-pay on an arbitrary number of the unit games set as a group; incrementing a count value, which is to be reset under a predetermined resetting condition, with every execution of the unit game on which the bet as a prerequisite for getting the insurance-pay is made; and providing a predetermined amount of award when the count value reaches a predetermined value in the group of the unit games on each of which the bet as a prerequisite for getting the insurance-pay is made.

A third aspect of the present invention provides a method of playing games using a gaming machine configured to execute unit games consecutively, which includes the steps of: making a bet on the unit games; providing a predetermined amount of award when a play result of the unit game satisfies a specific play result; making a bet, as a prerequisite for getting an insurance-pay, on an arbitrary number of the unit games set as a group; incrementing a count value, which is to be reset on a predetermined resetting condition, every time the unit game is executed; and paying out any of medals and coins corresponding to a predetermined amount of bets when the count value reaches a predetermined value in the group of unit games on each of which the bet as a prerequisite for getting the insurance-pay is made.

A fourth aspect of the present invention provides a gaming machine which includes: a display configured to display an image concerning a unit game for determining whether or not a play result deserves an award; a counter configured to be reset under a predetermined resetting condition and to increment a count value every time the unit game is executed; and a controller operable to execute the following procedures (a) to (c). The procedure (a) is to provide a predetermined amount of award when a play result of the unit game satisfies a specific play result. The procedure (b) is to receive a bet, as a prerequisite for getting an insurance-pay, made on an arbitrary number of the unit games set as a group. The procedure (c) is to provide a predetermined amount of award when the count value reaches a predetermined value in the group of unit games on each of which the bet as a prerequisite for getting the insurance-pay is made.

A fifth aspect of the present invention provides a gaming machine which includes: a display configured to display an image concerning a unit game for determining whether or not a play result deserves an award; a counter configured to be reset under a predetermined resetting condition and to increment a count value with every execution of the unit game on which a bet as a prerequisite for getting an insurance-pay is made; and a controller operable to execute the following procedures (a) to (c). The procedure (a) is to provide a predetermined amount of award when a play result of the unit game satisfies a specific play result. The procedure (b) is to receive a bet, as a prerequisite for getting the insurance-pay, made on an arbitrary number of the unit games set as a group. The procedure (c) is to provide a predetermined amount of award when the count value reaches a predetermined value in the group of unit games on each of which the bet as a prerequisite for getting the insurance-pay is made.

A sixth aspect of the present invention provides a gaming machine which includes: a display configured to display an image concerning a unit game for determining whether or not a play result deserves an award; a counter configured to be reset under a predetermined resetting condition and to increment a count value every time the unit game is executed; and a controller operable to execute the following procedures (a) to (c). The procedure (a) is to provide a predetermined amount of award when a play result of the unit game satisfies a specific play result. The procedure (b) is to receive a bet, as a prerequisite for getting an insurance-pay, made on an arbitrary number of the unit games set as a group. The procedure (c) is to payout any of medals and coins corresponding to a predetermined amount of bets when the count value reaches a predetermined value in the group of unit games on each of which the bet as a prerequisite for getting the insurance-pay is made.

### BRIEF DESCRIPTION OF THE DRAWINGS

FIG. 1 is a flowchart schematically showing procedures of a slot machine according to an embodiment of the present invention.

FIG. 2 is a perspective view of the slot machine according to the embodiment of the present invention.

FIG. 3 is a block diagram showing a control circuit of the slot machine according to the embodiment of the present invention.

FIG. 4 is a flowchart showing procedures of the slot machine according to the embodiment of the present invention.

FIG. 5 is a flowchart showing procedures of the slot machine according to the embodiment of the present invention.

FIG. 6 is a flowchart showing procedures of the slot machine according to the embodiment of the present invention.

FIG. 7 is a flowchart showing procedures of the slot machine according to the embodiment of the present invention.

FIG. 8 is a flowchart showing procedures of the slot machine according to the embodiment of the present invention.

FIG. 9 is a flowchart showing procedures of the slot machine according to the embodiment of the present invention.

FIG. 10 is a flowchart showing procedures of the slot machine according to the embodiment of the present invention.

FIG. 11 is a flowchart showing procedures of the slot machine according to another embodiment of the present invention.

FIG. 12 is a flowchart showing procedures of the slot machine according to the embodiment of the present invention.

FIG. 13 is a flowchart showing procedures of the slot machine according to the embodiment of the present invention.

FIG. 14 is a flowchart showing procedures of the slot machine according to the embodiment of the present invention.

FIG. 15 is a flowchart showing procedures of the slot machine according to another embodiment of the present invention.

FIG. 16 is a flowchart showing procedures of the slot machine according to the embodiment of the present invention.

FIG. 17 is a flowchart showing procedures of the slot machine according to the embodiment of the present invention.

FIG. 18 is a flowchart showing procedures of the slot machine according to another embodiment of the present invention.

FIG. 19 is a flowchart showing procedures of the slot machine according to the embodiment of the present invention.

FIG. 20 is a flowchart showing procedures of the slot machine according to the embodiment of the present invention.

FIG. 21 is a flowchart showing procedures of the slot machine according to another embodiment of the present invention.

FIG. 22 is a flowchart showing procedures of the slot machine according to the embodiment of the present invention.

FIG. 23 is a flowchart showing procedures of the slot machine according to the embodiment of the present invention.

FIG. 24 is a payout table showing relations between winning combinations and payouts of the slot machine according to the embodiment of the present invention.

FIGS. 25A and 25B are display examples to be displayed on a liquid crystal display of the slot machine according to the embodiment of the present invention.

FIG. 26 is a display example to be displayed on the liquid crystal display of the slot machine according to the embodiment of the present invention.

FIG. 27 is a display example to be displayed on the liquid crystal display of the slot machine according to the embodiment of the present invention.

FIGS. 28A and 28B are display examples to be displayed on the liquid crystal display of the slot machine according to the embodiment of the present invention.

FIG. 29A and FIG. 29B are display examples to be displayed on the liquid crystal display of the slot machine according to the embodiment of the present invention.

FIGS. 30A and 30B are display examples to be displayed on the liquid crystal display of the slot machine according to the embodiment of the present invention.

FIGS. 31A and 31B are display examples to be displayed on the liquid crystal display of the slot machine according to the embodiment of the present invention.

FIG. 32 is a display example to be displayed on the liquid crystal display of the slot machine according to the embodiment of the present invention.

### DETAILED DESCRIPTION OF THE EMBODIMENTS

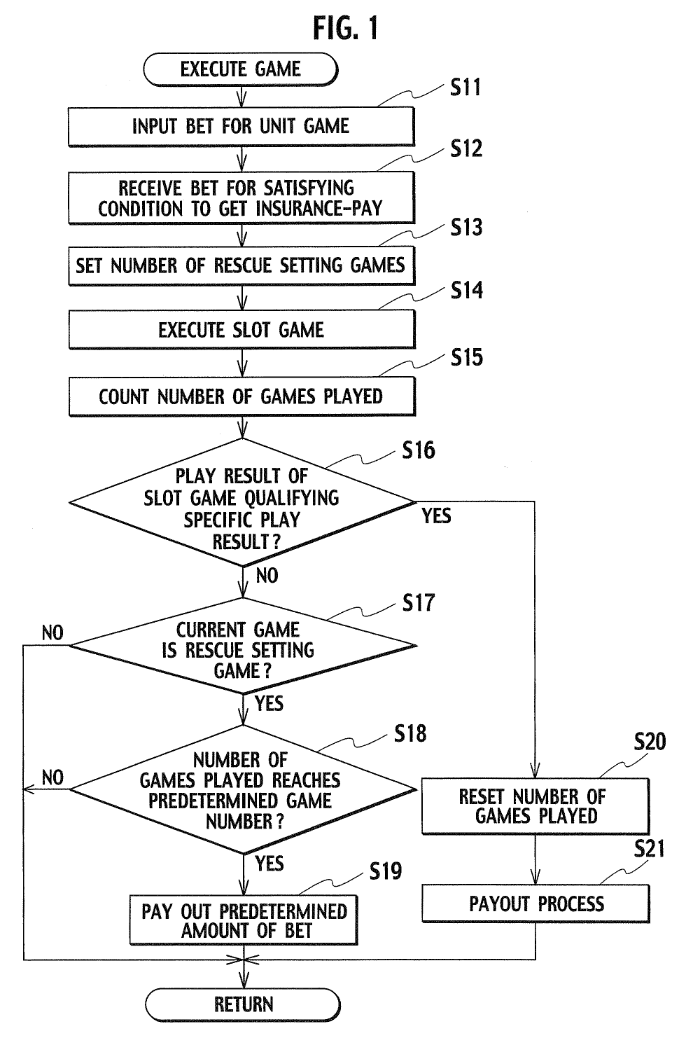

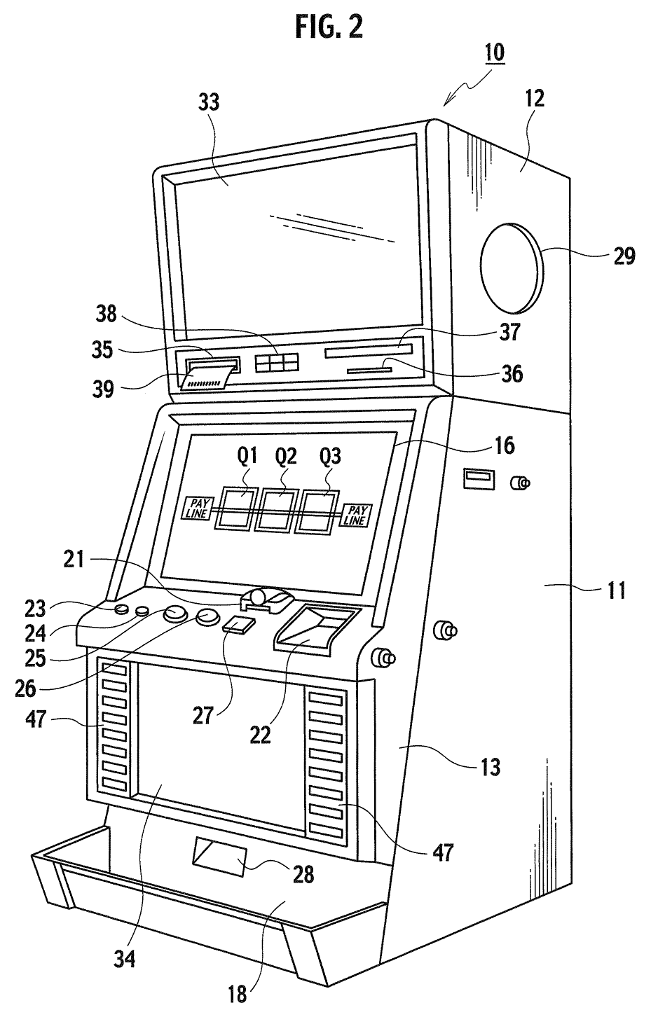

Now, outlines of operations of a slot machine representing an example of a gaming machine of the present invention will be described below with reference to a flowchart shown in FIG. 1 and a perspective view of a slot machine 10 shown in FIG. 2.

First, the slot machine 10 according to this embodiment receives a bet on a unit game constituting each round of execution of a slot game (Step S11). To be more precise, the slot machine 10 accepts insertion of medals or coins, or receives a bet using value information (credits).

Subsequently, the slot machine 10 receives a bet as a prerequisite for getting an insurance-pay (hereinafter referred to as a “rescue pay”; both of the “insurance-pay” and the “rescue pay” are trademark pending registrations) (Step S12). Here, as will be described later, the “rescue pay” means a predetermined amount of payout (award)(such as a payout (award) equivalent to 360 medals) to be granted either when the number of unit games not causing a predetermined amount of payout (award) (such as a payout (award) of 60 or more medals per bet) reaches an upper limit game number (such as 1000 games) or when aggregate bets in the consecutive unit games reaches an upper limit number (such as 3000 medals) without causing the predetermined amount of payout (award).

Thereafter, a rescue setting game number for determining whether or not the rescue pay is to be granted is set (Step S13). In the present invention, it is possible to set a rescue setting game for every predetermined number of games (such as a group of every 10 games) by making a predetermined amount of bet. Therefore, when a player makes the predetermined amount of bet to set the rescue setting game number to 10 games, a predetermined amount of bets will be paid out when the number of games reaches the upper limit game number or when the amount of bets made reaches the upper limit number during 10 slot games.

Subsequently, the slot games are executed (Step S14). In each slot game, symbols are scrolled in three display regions Q1 to Q3 as the player presses a start switch 27, and the symbols are stopped later. Then, if the symbols displayed in the respective regions Q1 to Q3 at this stopped timing, i.e. a play result of the slot game, match a winning combination, the payout corresponding to the winning combination is provided.

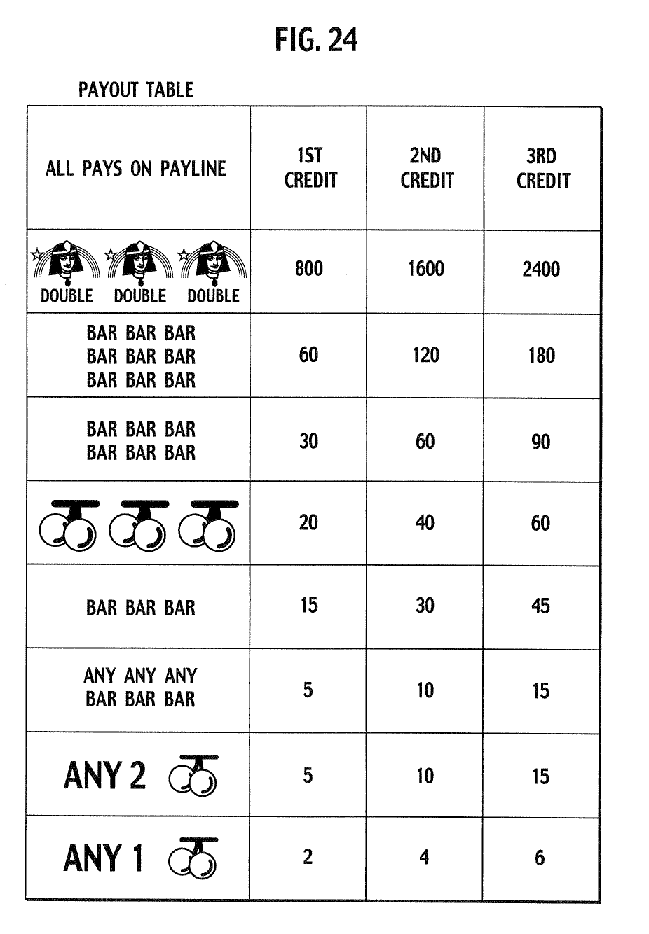

Thereafter, the number of the unit games played (or the number of credits consumed) is counted (Step S15). Moreover, a judgment is made as to whether or not the play result of the slot game satisfies a specific play result (Step S16). Here, the “specific play result” means a case where a payout becomes 60 medals or more per credit, for example. To be more precise, the specific play result may be a case where “DOUBLE” symbols (specific symbols) or “triple BAR” symbols (specific symbols) shown in FIG. 24 are aligned in the three display regions Q1 to Q3.

Then, if the specific play result takes place (YES in Step S16), the number of unit games played (or the number of credits consumed) counted in the process in Step S15 is reset (Step S20). Moreover, a payout is provided according to the specific play result (Step S21).

On the other hand, when the specific play result does not take place (NO in Step S16), a judgment is made as to whether or not the current unit game is the rescue setting game (Step S17). When the current unit game is the rescue setting game, a judgment is made as to whether or not the number of games played reaches the upper limit game number (the predetermined number) (Step S18). When the number of games played reaches the upper limit game number, the predetermined amount (such as 360 medals) of payout is provided (Step S19). Alternatively, a judgment is made as to whether or not the number of credits consumed reaches the upper limit number, and the predetermined amount of payout is provided when the number of credits consumed reaches the upper limit number.

Hence, it is possible to set the rescue setting games by defining an arbitrary number of unit games as a group. When the number of games played reaches the upper limit game number or when the number of credits consumed reaches the upper limit number during the rescue setting games, the predetermined amount of payout is provided as the rescue pay. Accordingly, if the player places a bet as a prerequisite for getting the rescue pay, the predetermined amount of payout is provided when no large payouts occur consecutively for numerous rounds (such as 1000 times) of the slot games and the number of games played reaches the upper limit game number (or the number of credits consumed reaches the predetermined number). Thus, the player can reduce loss of the bets.

Moreover, it is possible to place a bet as a prerequisite for getting the rescue pay for every predetermined number of games. Accordingly, the player can set the rescue setting games at his or her discretion.

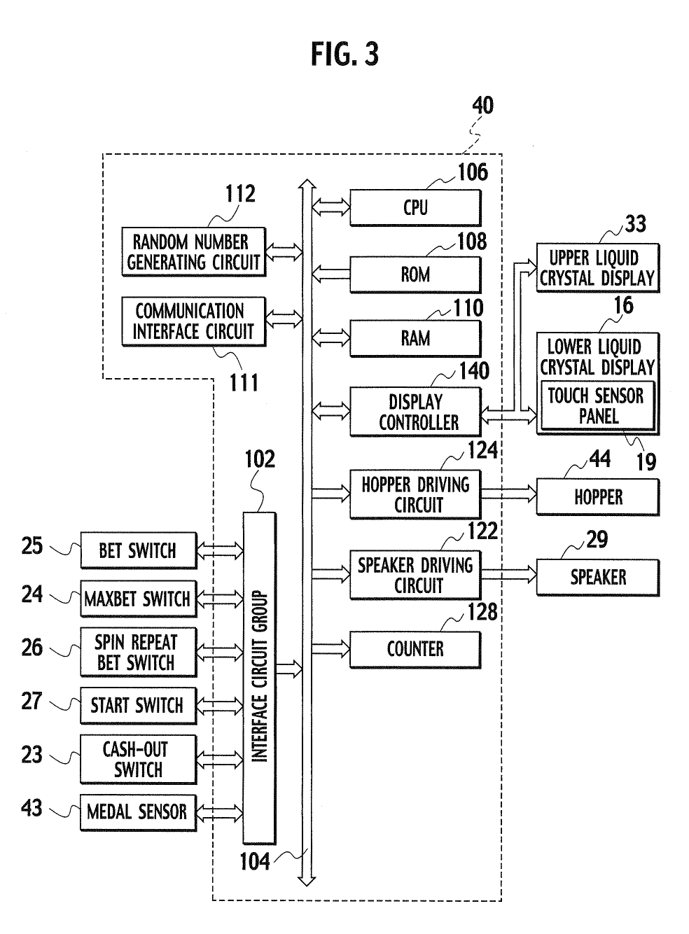

Next, a configuration of the slot machine 10 according to this embodiment will be described in detail. As shown in FIG. 2, the slot machine 10 of this embodiment includes a cabinet 11, a top box 12 to be disposed above the cabinet, and a main door 13. A lower liquid crystal display (a display) 16 is provided to the cabinet 11 to face a player. Moreover, various component members including a controller 40 (see FIG. 3) for electrically controlling this slot machine 10 and a hopper 44 (see FIG. 3) for controlling insertion, storage, and payouts of medals are disposed inside the cabinet 11.

Although this embodiment applies medals as an example of the bet used for playing the games, the form of the bet is not limited only to the medals. For instance, it is also possible to use coins, tokens, electronic money, and other electronic value information (credits) as the bet herein.

The main door 13 is openably and closably fitted to the cabinet 11, and the lower liquid crystal display 16 is disposed approximately in the center of this main door 13. As will be described later, the lower liquid crystal display 16 displays images concerning various games including the slot games. In a slot game, the symbols located in the three display regions Q1 to Q3 arranged horizontally are moved and rearranged. Then, the predetermined amount of payouts (medals, credits or the like) are provided when the symbols rearranged in the respective regions Q1 to Q3 match any of the winning combinations (see FIG. 24).

A medal insertion slot 21 for inserting the medals used for playing the game, and a bill validator 22 for identifying acceptable bills and for accepting authentic bills are provided below the lower liquid crystal display 16. Moreover, various operation switches are located in the vicinity of the medal insertion slot 21 and the bill validator 22.

A cash-out switch 23, a MAXBET switch 24, a BET switch 25, a spin repeat bet switch 26, and a start switch 27 are provided as the operation switches.

The BET switch 25 is the switch for determining the number of credits to be bet on the slot game executed on the lower liquid crystal display 16. A credit equivalent to one medal is bet every time the BET switch 25 is pressed.

The spin repeat bet switch 26 is the switch for betting the credits to play the slot game without changing the number of credits bet by use of the BET switch 25 in the previous game.

The start switch 27 is the switch for staring the slot game on the lower liquid crystal display 16 after betting the credits. When this start switch 27 is pressed after inserting the medal into the medal insertion slot 21 or betting the credits by use of the BET switch 25, the slot game is started in the display regions Q1 to Q3 on the lower liquid crystal display 16.

The cash-out switch 23 is the switch for paying out the inserted medals. The medals to be paid out are discharged from a medal payout opening 28 located at a lower part on a front face of the main door 13. The medals thus paid out are piled on a medal tray 18.

The MAXBET switch 24 is the switch for betting the maximum number of credits (such as 3 medals) that the player can bet in one round of the slot game in a single operation. Here, the maximum number of credits the player can bet in one round of the slot game may be changed by an operation of an administrator. For example, the player may be able to bet 50 medals at the maximum.

Afoot display 34 is disposed on a lower front face of the main door 13 and is configured to display various images concerning the games of the slot machine 10. The images may include characters and the like of the slot machine 10, for example.

Lamps 47 are located on both sides of the foot display 34, which are configured to emit light based on predetermined light emission patterns in response to the gaming of the slot machine 10. The medal payout opening 28 is located below the foot display 34.

An upper liquid crystal display 33 is disposed on a front face of the top box 12. The number of medals to be paid out corresponding to combinations of the symbols, and other effect images are displayed on this upper liquid crystal display 33.

Moreover, a speaker 29 is provided on the top box 12. A ticket printer 35, a card reader 36, a data display 37, and a keypad 38 are located below the upper liquid crystal display 33. The ticket printer 35 is configured to print a bar code for coding various data including the number of credits, date and time, an identification number of the slot machine 10 and the like on a ticket, and to output the ticket as a bar-coded ticket 39.

The player is able to play with a different slot machine by allowing the slot machine to read the bar-coded ticket 39, and to exchange the bar-coded ticket 39 with banknotes and the like in a designated position of a gaming facility (such as a cashier in a casino).

The card reader 36 is configured to allow insertion of a smart card, to read data from the inserted smart card, and to write data thereto. The smart card is a card carried by the player, which stores data for identifying the player, data concerning a history of games played by the player, and so forth.

FIG. 3 is a block diagram showing an electric configuration of the controller 40 provided on the slot machine 10 of this embodiment and various instruments to be connected to the controller 40. The controller 40 of the slot machine 10 shown in FIG. 3 is a microcomputer, which includes an interface circuit group 102, an input-output bus 104, a CPU 106, a ROM 108, a RAM 110, a communication interface circuit 111, a random number generating circuit 112, a speaker driving circuit 122, a hopper driving circuit 124, a counter 128, and a display controller 140.

The interface circuit group 102 is connected to the input-output bus 104. This input-output bus 104 executes input and output of data signals or address signals to and from the CPU 106.

The start switch 27 is connected to the interface circuit group 102. A start signal outputted from this start switch 27 is converted into a predetermined signal by the interface circuit group 102 and is then transmitted to the CPU 106 through the input-output bus 104.

Moreover, the BET switch 25, the MAXBET switch 24, the spin repeat bet switch 26, and the cash-out switch 23 are connected to the interface circuit group 102. Switching signals outputted from these switches 25, 24, 26, and 23 are supplied to the interface circuit group 102, converted into predetermined signals by the interface circuit group 102, and then transmitted to the CPU 106 through the input-output bus 104.

In addition, a medal sensor 43 is connected to the interface circuit group 102. The medal sensor 43 is the sensor for detecting the medals inserted into the medal insertion slot 21, which is provided in a medal insertion region of the medal insertion slot 21. A detection signal outputted from this medal sensor 43 is supplied to the interface circuit group 102, then converted into a predetermined signal by this interface circuit group 102, and then transmitted to the CPU 106 through the input-output bus 104.

The ROM 108 for storing a system program and the RAM 110 for saving various data are connected to the input-output bus 104. Moreover, the random number generating circuit 112, the communication interface circuit 111, the display controller 140, the hopper driving circuit 124, the speaker driving circuit 122, and the counter 128 are also connected to the input-output bus 104.

The CPU 106 reads a game execution program and executes the slot game on accepting a starting operation of the game by the start switch 27. The game execution program is the program for executing the slot game on the lower liquid crystal display 16 through the display controller 140.

To be precise, the game execution program is programmed to execute the slot game so as to scroll the symbols in the display regions Q1 to Q3 (see FIG. 2), then to stop the symbols (rearranges the symbols), and to cause a payout when the stopped symbols match a winning combination.

The communication interface 111 is connected to a hall server or the like and is configured to transmit data such as a history of the gaming executed by the slot machine 10, to the hall server. Moreover, the communication interface 111 receives various data transmitted from the hall server.

The random number generating circuit 112 generates a random number for determining whether or not to cause the winning combination in the slot game executed on the lower liquid crystal display 16.

The counter 128 has a function to count the execution number of the unit games, i.e. the number of slot games (the number of games played) executed in the display regions Q1 to Q3, a function to count the number of medals inserted in each of the slot games that are consecutively executed, and a function to count the difference between the number of inserted medals and the number of paid out medals in each of the slot games that are consecutively executed. Here, the “number of medals inserted in each of the slot games that are consecutively executed” means an accumulated value of the inserted medals. Assuming that 10 rounds of the slot games are executed while betting 3 medals every time, then the number of inserted medals is 30. Meanwhile, the “difference between the number of inserted medals and the number of paid out medals in each of the slot games that are consecutively executed” means a value calculated by subtracting the paid out medals from the accumulated value of the inserted medals. For example, assuming that 10 rounds of the slot games are executed while betting 3 medals every time and that a payout equivalent to 10 medals or credits occurs during the 10 rounds of slot games, then the difference is 20 medals. It is also possible to set the counter 128 inside the RAM 110.

The speaker driving circuit 122 outputs a voice signal to the speaker 29. Specifically, the CPU 106 reads voice data that are stored in the ROM 108 and transmits the voice data to the speaker driving circuit 122 through the input-output bus 104. In this way, predetermined sound effects are outputted from the speaker 29.

The hopper driving circuit 124 outputs a payout signal to the hopper 44 when a cash-out occurs. Specifically, when the a cash-out signal is inputted from the cash-out switch 23, the CPU 106 outputs a drive signal to the hopper driving circuit 124 through the input-output bus 104. In this way, the hopper 44 pays out the medals corresponding to the remaining credits stored in a predetermined memory region of the RAM 110 at that point.

The display controller 140 performs display control for executing the slot game on the lower liquid crystal display 16. Specifically, the CPU 106 generates image display command signals corresponding to a state of a slot game and a result of the slot game, and outputs the image display command signals to the display controller 140 through the input-output bus 104. When the image display command signals outputted from the CPU 106 are inputted, the display controller 140 generates drive signals for driving the lower liquid crystal display 16 based on these image display commands and outputs the generated drive signals to the lower liquid crystal display 16. In this way, various images including effect images and images for explaining the game are displayed on the lower liquid crystal display 16.

Moreover, a touch panel sensor 19 is provided on a surface of the lower liquid crystal display 16. When the player touches this touch panel sensor 19, data representing the touched position on the lower liquid crystal display 16 are detected and the data are transmitted to the CPU 106.

Furthermore, the display controller 140 performs control to display various images including effect images and images for explaining the game on the upper liquid crystal display 33.

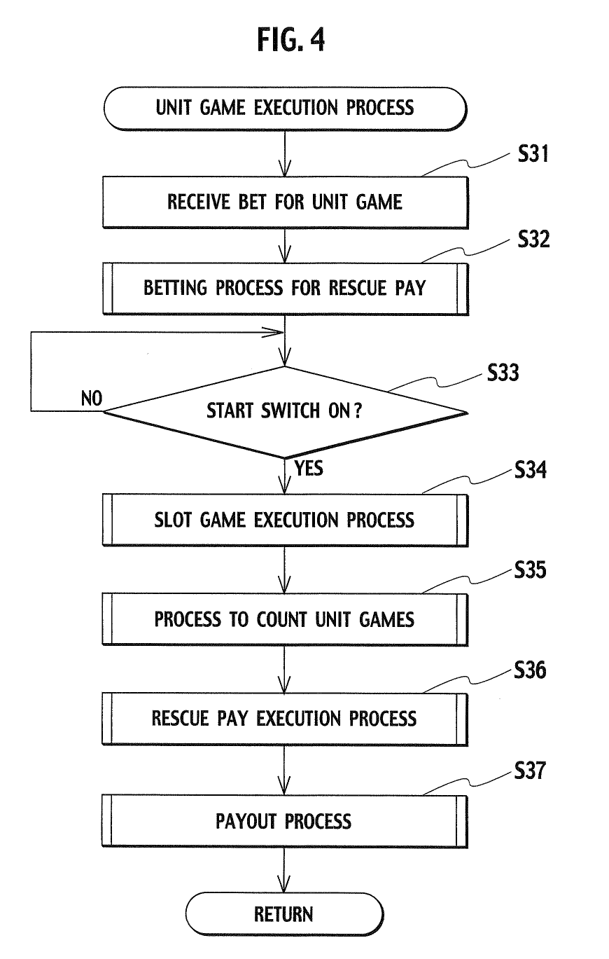

Next, procedures for executing the unit game constituting each round of execution of the slot game with the slot machine 10 serving as the gaming machine according to the first embodiment of the present invention will be described with reference to flowcharts shown in FIG. 4 to FIG. 9.

When the unit game is executed, in Step S31 in FIG. 4, the CPU 106 shown in FIG. 3 receives a bet. To be more precise, when the medals are inserted from the medal insertion slot 21 or when the credits are bet by means of pressing the MAXBET switch 24 or the BET switch 25, these operations are detected by the CPU 106.

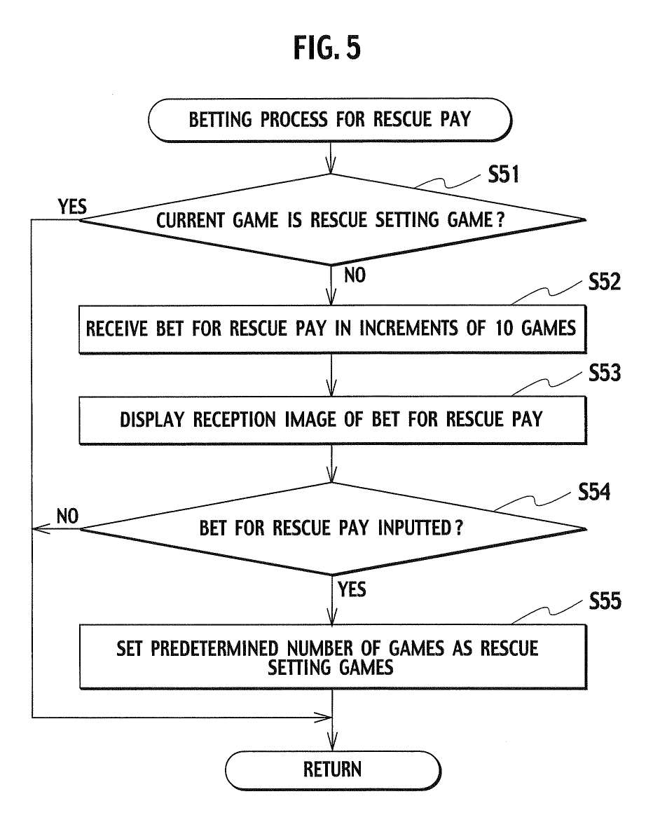

Subsequently, in Step S32, the CPU 106 carries out a betting process for the rescue pay. In this process, the CPU 106 accepts a bet for the rescue pay by using the touch panel sensor 19 provided on the lower liquid crystal display 16. More details will be described with reference to the flowchart shown in FIG. 5.

Thereafter, in Step S33, the CPU 106 judges whether or not the start switch 27 is turned on. The procedure goes to Step S34 when the start switch 27 is turned on.

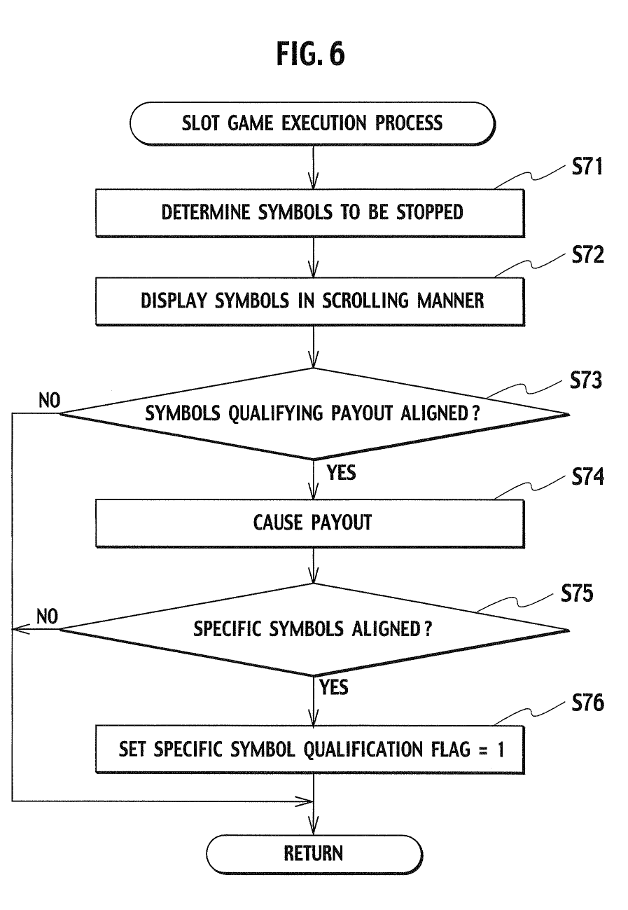

In Step S34, the CPU 106 carries out an execution process of the slot game. In this process, the CPU 106 executes a process for rearranging the symbols located in the three display regions Q1 to Q3. More details will be described with reference to the flowchart shown in FIG. 6.

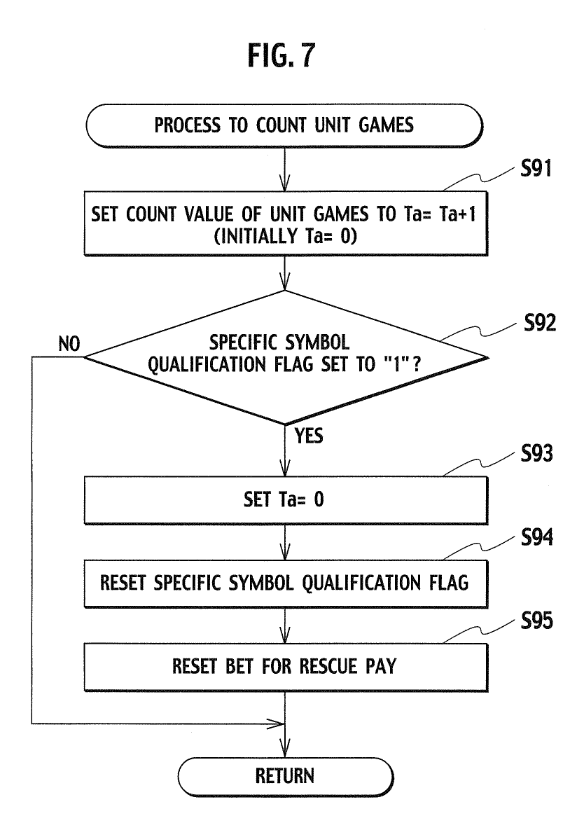

In Step S35, the CPU 106 carries out a process to count the unit games. In this process, the CPU 106 executes the process to increment the count value in the counter 128 every time the unit game is executed. More details will be described with reference to the flowchart shown in FIG. 7.

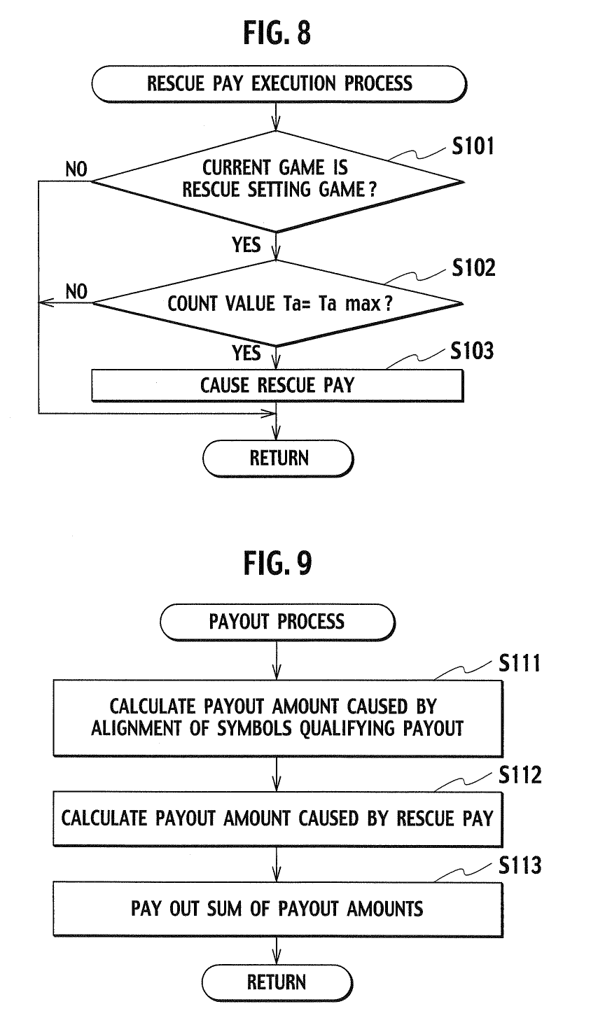

In Step S36, the CPU 106 carries out a rescue pay execution process. In this process, a payout equivalent to a preset number of medals (such as 360 medals) is granted when no unit games causing a predetermined amount of payout (such as 60 or more medals) occur within a predetermined number (such as 1000 games) of unit games. More details will be described with reference to the flowchart shown in FIG. 8.

In Step S37, the CPU 106 carries out a payout process. In this process, the payout (such as medals or credits) is provided either when the symbols qualifying the winning combinations stop in the three display regions Q1 to Q3 or when the rescue pay is granted. Thereafter, the process goes to the next unit game.

FIG. 5 is the flowchart showing detailed procedures of the betting process for the rescue pay shown in Step S32 in FIG. 4. First, in Step S51, the CPU 106 judges whether or not the current unit game is the rescue setting game. Then, the process goes to Step S52 when the current unit game is not the rescue setting game (NO in Step S51) or the process is terminated when the current unit game is the rescue setting game (YES in Step S51).

In Step S52, the main CPU 106 accepts a bet for the rescue pay for every 10 games. Next, in Step S53, a bet acceptance image for the rescue pay is displayed on the upper liquid crystal display 33 and the lower liquid crystal display 16.

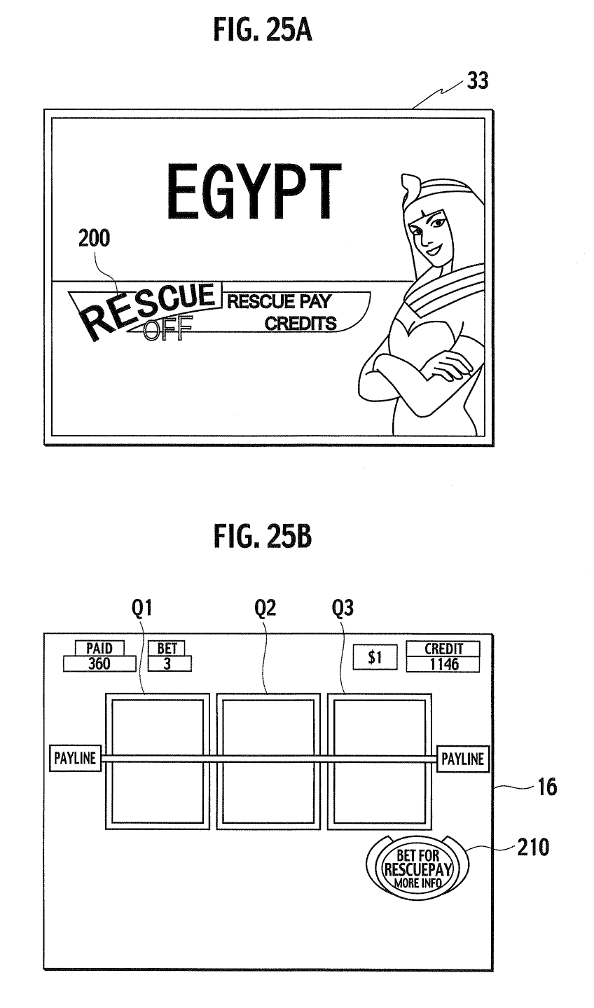

FIG. 25A is a display example of the upper liquid crystal display 33. FIG. 25B is a display example of the lower liquid crystal display 16. In FIG. 25A, an image 200 showing a character string of “RESCUE OFF” is displayed in order to indicate a state that no bet is currently made for the rescue pay. Meanwhile, in FIG. 25B, a selection image 210 is displayed for selecting a display of detailed explanation of the rescue pay. Moreover, when a player touches this selection screen 210, this touch operation is detected by the touch panel sensor 19 (see FIG. 3).

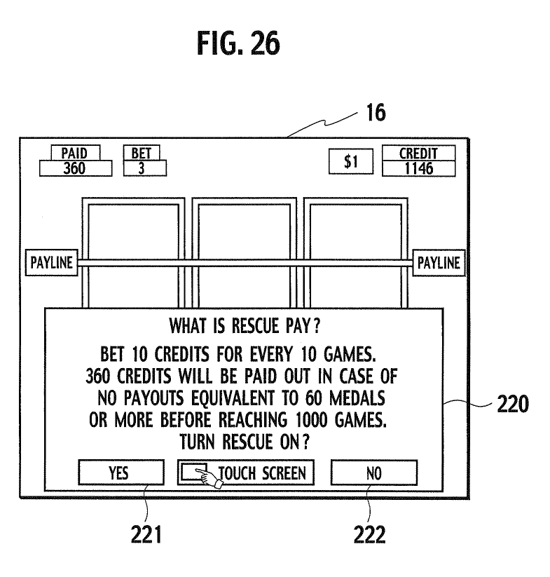

Thereafter, an explanation image 220 concerning the rescue pay is displayed as shown in FIG. 26. Here, sentences such as “What is rescue pay? Bet 10 credits for every 10 games. 360 credits will be paid out in case of no payouts equivalent to 60 medals or more before reaching 1000 games. Turn RESCUE on?” are displayed. In this way, the detailed contents of the rescue pay are notified to the player. At the same time, the player is urged to select either a selection image 221 indicating “YES” or a selection image 222 indicating “NO”.

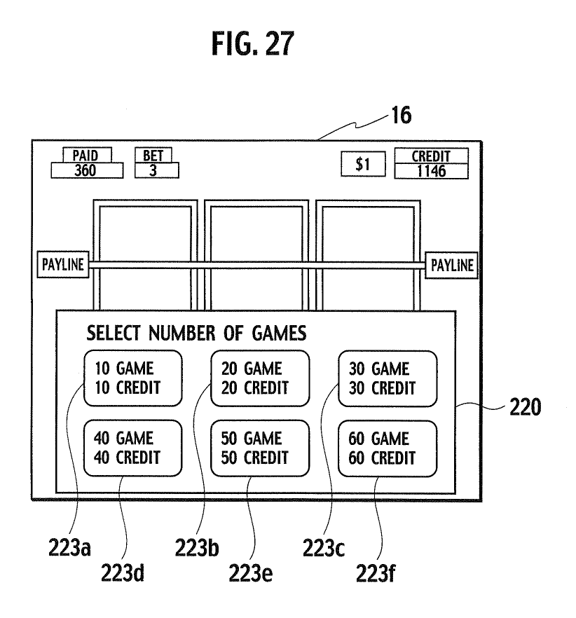

Here, when the player selects the selection image 221 indicating “YES”, the lower liquid crystal display 16 displays an explanation image 220 as in FIG. 27, that includes selection images 223a to 223f for selecting the rescue setting game number. To be more precise, the images “10 games, 10 credits”, “20 games, 20 credits”, “30 games, 30 credits”, “40 games, 40 credits”, “50 games, 50 credits”, and “60 games, 60 credits” are displayed. Accordingly, the player is notified that it is possible to set the rescue setting games by defining every 10 games as a unit and that it is necessary to bet 10 credits for setting 10 games for the rescue setting games.

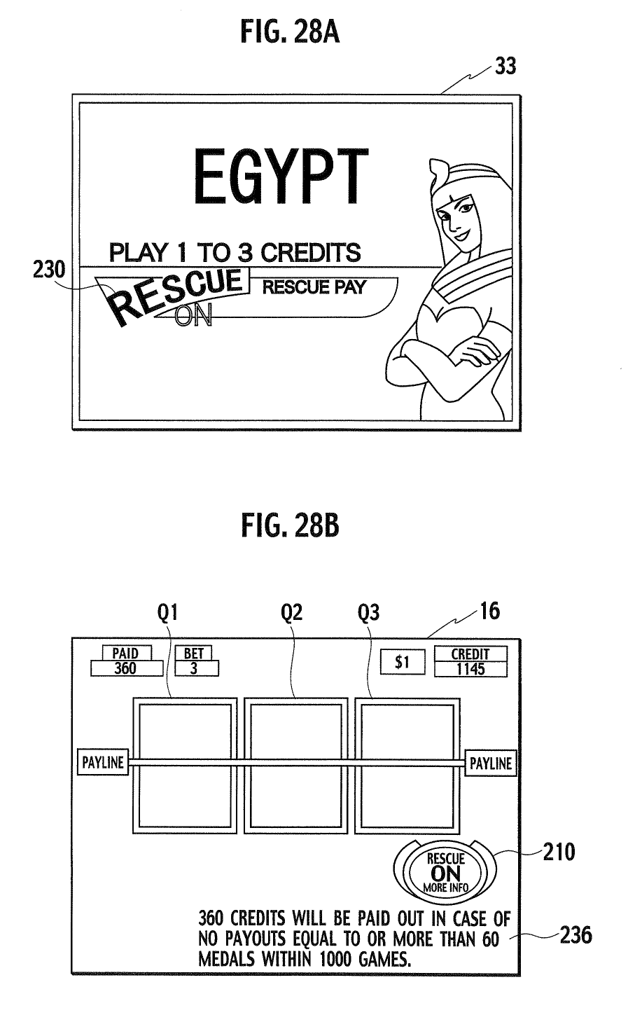

Now, when the a bet is made for the rescue pay, a character string image 230 “RESCUE ON” is displayed on the upper liquid crystal display 33 as shown in FIG. 28A and an image 236 stating a sentence such as “360 credits will be paid out in case of no payouts equivalent to 60 medals or more during 1000 games.” is displayed on the lower liquid crystal display 16 as shown in FIG. 28B. That is, these image displays notify the player that the current unit game is the rescue setting game.

Subsequently, in Step S54 in FIG. 5, a judgment is made as to whether or not the bet is made for the rescue pay. Specifically, the judgment is made as to whether or not the player selects any of the selection images 223a to 223f shown in FIG. 27. Here, the process is terminated when none of the selection images 223a to 223f is selected (NO in Step S54). On the other hand, the process goes to Step S55 when the player selects any of the selection images 223a to 223f.

In Step S55, the CPU 106 sets the number of games corresponding to any of the selection images 223a to 223f selected by the player, as the rescue setting games. For example, when the selection image 223b corresponding to the “20 games, 20 credits” out of six pieces of the selection images 223a to 223f is selected, the 20 rounds of unit games starting from the current unit game are set as the rescue setting games. Moreover, 20 credits are bet by this selection. Thereafter, this process is terminated.

FIG. 6 is the flowchart showing the slot game execution procedures shown in Step S34 in FIG. 4. Now, the slot game execution procedures will be described with reference to this drawing.

First, in Step S71, the CPU 106 determines the symbols to be stopped in the respective display regions Q1 to Q3 based on random numbers generated by the random number generating circuit 112 (see FIG. 3). Subsequently, in STEP S72, the displays of the symbols are scrolled in the display regions Q1 to Q3. Moreover, the displays of the symbols are stopped after a lapse of a predetermined time period (such as 5 seconds). The displays of the symbols stopped at this time are the symbols determined in Step S71. Thereafter, the process goes to Step S73.

In Step S73, the CPU 106 judges whether the symbols stopped in the display regions Q1 to Q3 satisfy any of the winning combinations for causing the payout. The winning combinations are defined based on a payout table shown in FIG. 24. To be more precise, a payout of 800 credits per credit is qualified when three “DOUBLE” symbols are aligned in the display regions Q1 to Q3. Meanwhile, a payout of 60 credits per credit is qualified when three “triple BAR” symbols are aligned in the display regions Q1 to Q3. Likewise, payouts corresponding to combinations of three “double BAR” symbols, three “CHERRY” symbols, three “single BAR” symbols, three of any of the above “triple BAR”, “double BAR” and “single BAR” symbols (ANYBAR), two “CHERRY” symbols, and a single “CHERRY” symbol are determined in accordance with the payout table.

In Step S74, the CPU 106 executes a process to cause the payout corresponding to the above-described winning combination. In Step S75, the CPU 106 judges whether or not specific symbols are aligned in the display regions Q1 to Q3. In this embodiment, the winning combination for qualifying a payout equal to or more than 60 credits per credit is defined as the specific symbols. Accordingly, the judgment that the specific symbols are aligned is made when three “DOUBLE” symbols are aligned or when three “triple BAR” symbols are aligned as shown in FIG. 24.

Then, in Step S75, the CPU 106 sets a specific symbol qualification flag to “1”. Thereafter, this process is terminated.

That is to say, the slot game execution process shown in FIG. 6 causes the payout corresponding to the winning combination when the winning combination is aligned. At the same time, the slot game execution process causes the payout corresponding to the specific symbols when the specific symbols (which are the “DOUBLE” symbols or the “triple BAR” symbols in this embodiment) to provide a large benefit to the player are aligned, and sets the specific symbol qualification flag to “1”.

Next, the process to count the unit games shown in Step S35 in FIG. 4 will be described with reference to the flowchart shown in FIG. 7.

First, in Step S91, the CPU 106 increments a count value Ta of the unit games. That is, Ta=Ta+1 is set. Here, the count value Ta is initially set to 0 (at the time of turning the power on), and will be reset in the procedure in Step S93 to be described later. Here, the count value Ta is the value obtained by counting the executed rounds of the unit games. After finishing this procedure, the process goes to Step S92.

In Step S92, the CPU 106 judges whether or not the specific symbol qualification flag is set to “1”. Specifically, the judgment is made as to whether or not the specific symbol qualification flag shown in Step S76 in FIG. 6 is set to “1”. Here, when the specific symbol qualification flag is set to “1” (YES in Step S92), the CPU 106 resets the count value Ta in the procedure in Step S93.

Moreover, the CPU 106 resets the specific symbol qualification flag in Step S94 and resets the bet for the rescue pay in Step S95. That is, when the player is granted a large benefit equal to or more than 60 credits per credit, the count value Ta of the unit games is reset and the bet for the rescue pay executed in Step S32 in FIG. 4 is also reset.

Meanwhile, the process is terminated when the judgment is made in the judgment process in Step S92 that the specific symbol qualification flag is not set to “1”. Specifically, when the specific symbol qualification flag is not set to “1”, the next unit game takes place while incrementing the count value Ta. Then this process is terminated.

In the above-described process to count the unit games, the count value Ta is incremented when the winning combination to cause the payout equal to or more than 60 credits per credit is not qualified (when the specific symbols are not qualified). Meanwhile, the count value Ta is reset when the winning combination to cause the payout equal to or more than 60 credits per credit is qualified (when the specific symbols are qualified). In this way, the unit games not qualifying the specific symbols are consecutively counted.

Next, the procedures of the rescue pay execution process shown in Step S36 in FIG. 4 will be described with reference to the flowchart shown in FIG. 8. First, in Step S101, the CPU 106 judges whether or not the current unit game is the rescue setting game. Specifically, in the process shown in Step 55 in FIG. 5, the judgment is made as to whether or not the current unit game is the unit game set as the rescue setting game. Here, the process goes to Step S102 when the current unit game is the rescue setting game or the process is terminated when the current unit game is not the rescue setting game.

In Step S102, the CPU 106 judges whether or not the count value Ta of the unit games is equal to a preset upper limit value (a predetermined value) Ta max (Ta max=1000 , for example). Here, the process goes to Step S103 when Ta is equal to Ta max or the process is terminated when Ta is not equal to Ta max.

In Step S103, the CPU 106 carries out the process to cause the rescue pay. Specifically, if the specific symbols are not qualified consecutively in the number equivalent to the upper limit value Ta max, or to be precise, if the winning combination qualifying the payout equal to or more than 60 credits per credit does not occur consecutively, then the predetermined rescue pay (such as the payout equivalent to 360 coins) becomes effective.

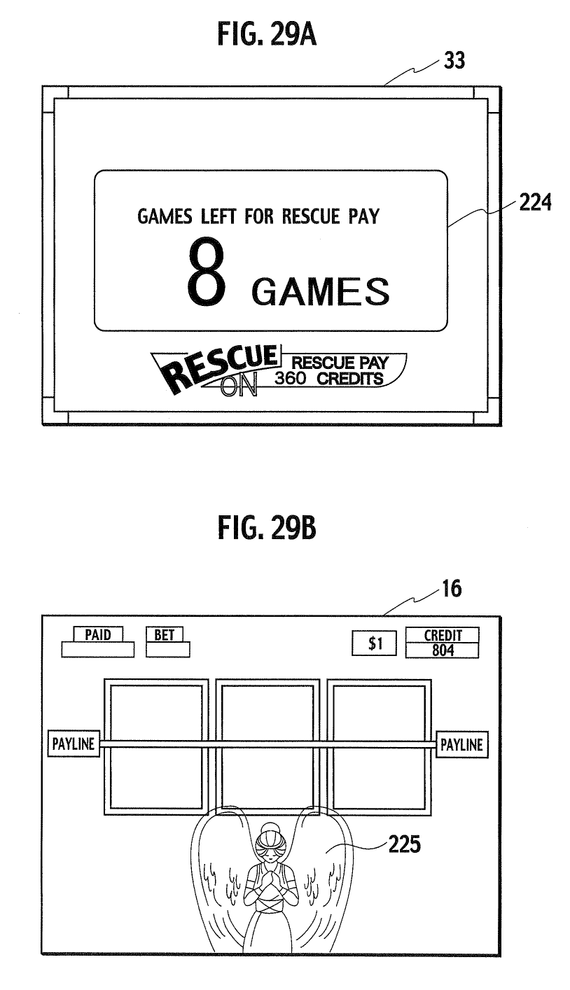

FIGS. 29A and 29B are display examples of images to be displayed on the upper liquid crystal display 33 and the lower liquid crystal display 16 when the count value Ta is coming close to the upper limit value Ta max. As shown in these examples, when the count value Ta is “992”, an image 224 for notifying the player that there are 8 games left before the rescue pay becomes effective. Meanwhile, an image 225 of an angel with folded wings is displayed on the lower liquid crystal display 16.

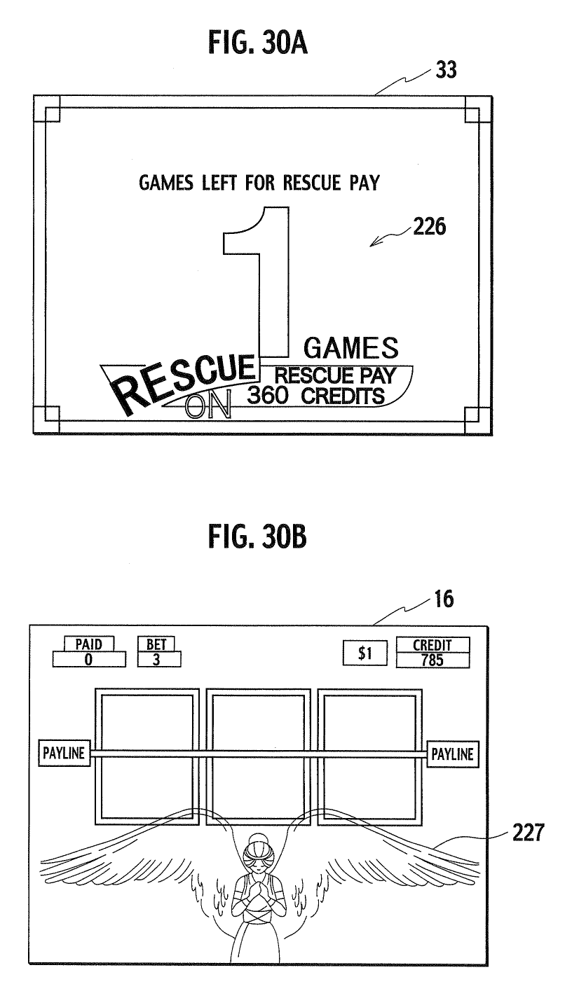

FIGS. 30A and. 30B are display examples of images to be displayed on the upper liquid crystal display 33 and the lower liquid crystal display 16 when the count value Ta is “999”. As shown in these examples, an image 226 for notifying the player that there is 1 game left before the rescue pay becomes effective. Meanwhile, an image 227 of the angel unfolding the wings is displayed on the lower liquid crystal display 16.

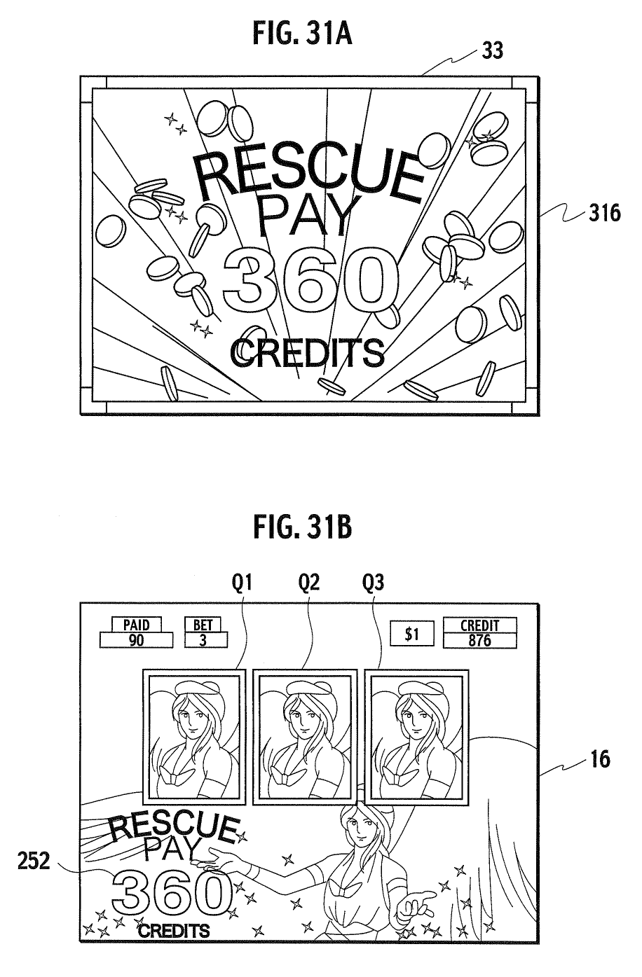

FIGS. 31A and. 31B are display examples of images to be displayed on the upper liquid crystal display 33 and the lower liquid crystal display 16 when the count value Ta reaches the upper limit value Ta max “1000 ”. As shown in these examples, images 316 and 252 indicating that the rescue pay equivalent to 360 medals has become effective are displayed on the upper liquid crystal display 33 and the lower liquid crystal display 16, respectively.

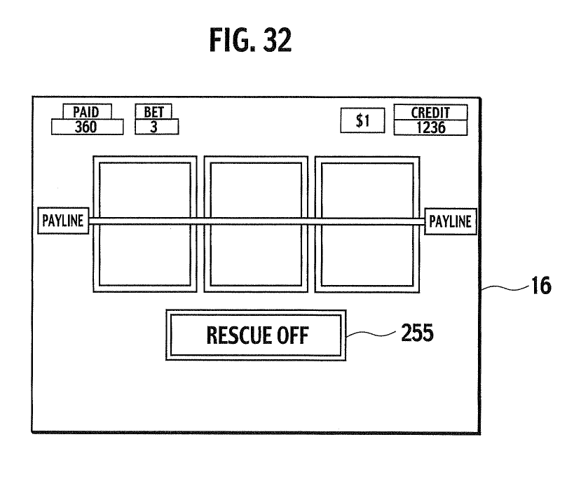

FIG. 32 is a display example of an image to be displayed on the lower liquid crystal display 16 after the rescue pay has been paid out. In this example, an image 255 is displayed, the image indicating that the rescue pay is currently turned off as the rescue pay has already been paid out. In this way, the rescue pay execution process shown in FIG. 8 is carried out.

Next, the payout process shown in Step S37 in FIG. 4 will be described with reference to the flowchart shown in FIG. 9. First, in Step S111, the CPU 106 calculates a payout amount caused by alignment of the symbols qualifying the payout, i.e. alignment of the winning combination. Thereafter, the process goes to Step S112.

In Step S112, the CPU 106 calculates a payout amount caused by the rescue pay. That is, when the rescue pay becomes effective in the procedure in Step S103 in FIG. 8, the payout amount corresponding to this rescue pay is calculated. In this embodiment, this payout amount is 360 medals. Thereafter, the process goes to Step S113.

In Step S113, the CPU 106 calculates a sum of the payout amount caused by the winning combination and the payout amount caused by the rescue pay, and provides a payout corresponding to this sum by use of the medals or coins from the payout opening 28 shown in FIG. 2. Then, this process is terminated.

In this way, according to the slot machine 10 of this embodiment, the rescue pay is paid out when the count value reaches the upper limit value Ta max (the predetermined value) during the rescue setting games.

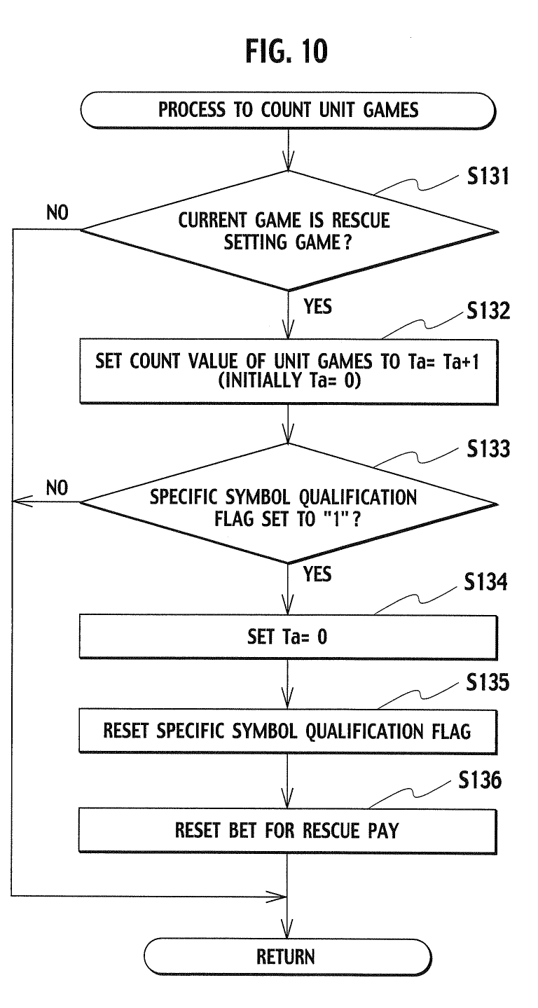

Next, a modified example of the above-described first embodiment will be described. In this modified example, only the process to count the unit games shown in Step S35 in FIG. 4 is different from the above-described first embodiment. Now, the process to count the unit games in the modified example will be described with reference to a flowchart shown in FIG. 10.

First, in Step S131, the CPU 106 judges whether or not the current unit game is the rescue setting game. Specifically, the judgment is made as to whether or not the current unit game is the unit game set as the rescue setting game in the procedure in Step S55 in FIG. 5. Then, the process goes to Step S132 when the current game is set as the rescue setting game (YES in Step S131). Here, the procedures in Steps S132 to S136 are the same as Steps S91 to S95 in FIG. 7 and detailed explanation of these procedures will therefore be omitted.

On the contrary, when the current unit game is not the rescue setting game (NO in Step S131), the process is terminated without incrementing the count value Ta. Specifically, the count value Ta is not incremented in the unit game which is not set as the rescue setting game. In other words, the count value Ta will be incremented only in the unit games set as the rescue setting games.

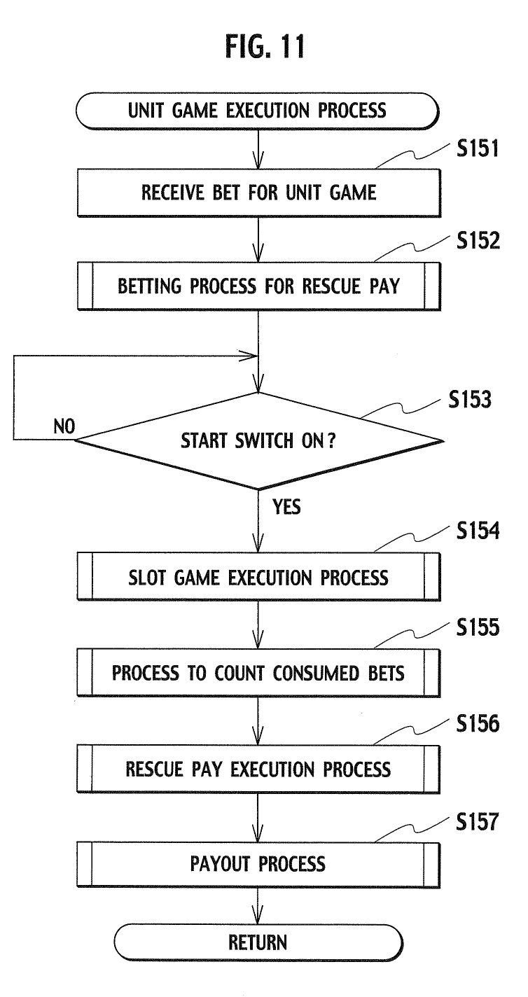

Next, a second embodiment of the present invention will be described. FIG. 11 is a flowchart showing procedures of unit games to be executed by the slot machine 10 serving as the gaming machine according to the second embodiment. Comparing the unit game execution process shown in FIG. 11 with the unit game execution process shown in FIG. 4, Steps S151 to 154 shown in FIG. 11 are the same as Steps S31 to S34 shown in FIG. 4. Similarly, Step S157 shown in FIG. 11 is the same as Step S37 shown in FIG. 4. On the contrary, Steps S155 and S156 shown in FIG. 11 are different from Steps S35 and S36 shown in FIG. 4.

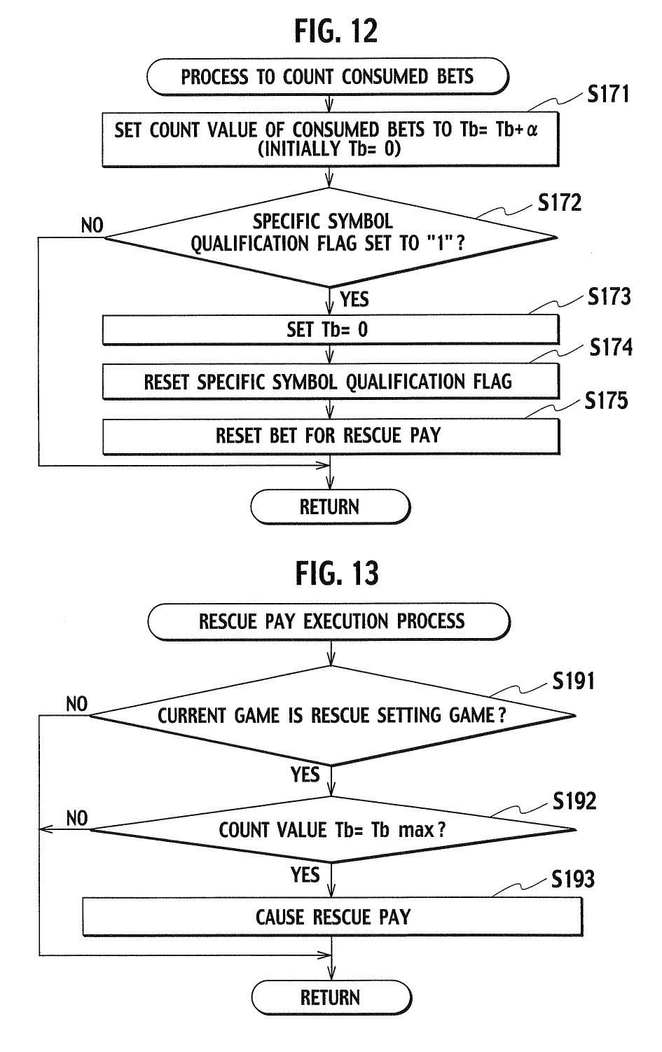

Now, a process to count consumed bets indicated in Step S155 in FIG. 11 will be described with reference to a flowchart shown in FIG. 12.

First, in Step S171, the CPU 106 adds a count value a corresponding to a newly-made bet to a count value of bets consumed at present (an accumulated value of the consumed bets) Tb. That is, the CPU 106 calculates Tb=Tb+α. Here, the count value Tb is initially set to 0 (at the time of turning the power on), and will be reset in the procedure in Step S173 to be described later. Here, the count value Tb is the accumulated value of the bets (the number of medals or the number of credits) invested in the consecutive unit games. For example, when a bet is made with three medals in one unit game, the value a is equal to 3 and the count value is therefore expressed by Tb=Tb+3. After finishing this procedure, the process goes to Step S172.

In Step S172, the CPU 106 judges whether or not the specific symbol qualification flag is set to “1”. Specifically, the judgment is made as to whether or not the specific symbol qualification flag shown in Step S76 in FIG. 6 is set to “1”. Here, when the specific symbol qualification flag is set to “1” (YES in Step S172), the CPU 106 resets the count value Tb in the procedure in Step S173.

Moreover, the CPU 106 resets the specific symbol qualification flag in Step S174 and resets the bets for the rescue pay in Step S175. That is, when the player is granted a large benefit equal to or more than 60 credits per credit, the count value Tb of the unit games is reset and the bet for the rescue pay executed in Step S12 in FIG. 11 is also reset.

Meanwhile, the process is terminated when the judgment is made in Step S172 that the specific symbol qualification flag is not set to “1” (NO in Step S172). Specifically, when the specific symbol qualification flag is not set to “1”, the next unit game takes place while counting the count value Tb. Then this process is terminated.

In the above-described counting process, the count value α (α=3, for example) corresponding to the bet is added to the count value Tb when the winning combination to cause the payout equal to or more than 60 credits per credit is not qualified (when the specific symbols are not qualified). In this way, the amount of bets consumed in the unit games not qualifying the specific symbols is consecutively counted. Meanwhile, the count value Tb is reset when the winning combination to cause the payout equal to or more than 60 credits per credit is qualified (when the specific symbols are qualified).

Next, the procedures of the rescue pay execution process shown in Step S156 in FIG. 11 will be described with reference to a flowchart shown in FIG. 13. First, in Step S191, the CPU 106 judges whether or not the current unit game is the rescue setting game. Specifically, in the process shown in Step 55 in FIG. 5, the judgment is made as to whether or not the current unit game is the unit game set as the rescue setting game. Here, the process goes to Step S192 when the current unit game is the rescue setting game or the process is terminated when the current unit game is not the rescue setting game.

In Step S192, the CPU 106 judges whether or not the count value Tb of the consumed bets is equal to a preset upper limit value Tb max (Tb max=3000, for example). Here, the process goes to Step S193 when Tb is equal to Tb max or the process is terminated when Tb is not equal to Th max.

In Step S193, the CPU 106 carries out the process to cause the rescue pay. Specifically, if the specific symbols are not qualified even when the bet equivalent to the upper limit value Tb max is invested, or to be precise, if the winning combination qualifying the payout equal to or more than 60 credits per credit does not occur, then the predetermined rescue pay (such as the payout equivalent to 360 coins) becomes effective.

In this way, according to the slot machine as the gaming machine according to the second embodiment of the present invention, the rescue pay is paid out when the count value Tb (the accumulated value of the consumed bets) reaches the upper limit value Tb max during the rescue setting games.

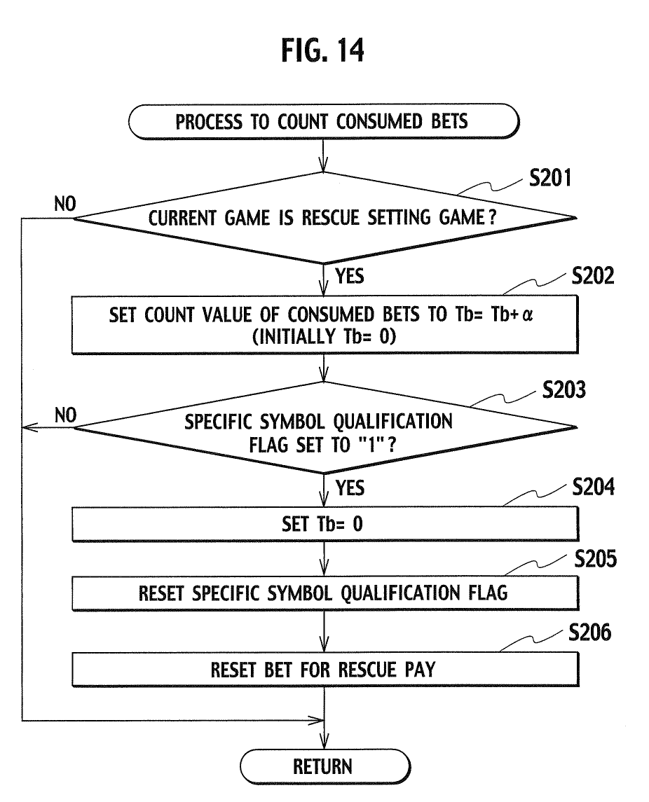

Next, a modified example of the above-described second embodiment will be described with reference to a flowchart shown in FIG. 14. In this modified example, only the process to count the consumed bets shown in Step S155 in FIG. 11 is different from the above-described second embodiment. Now, the process to count the consumed bets in the modified example will be described with reference to the flowchart shown in FIG. 14.

First, in Step S201, the CPU 106 judges whether or not the current unit game is the rescue setting game. Specifically, the judgment is made as to whether or not the current unit game is the unit game set as the rescue setting game in the procedure in Step S55 in FIG. 5. Then, the process goes to Step S202 when the current game is set as the rescue setting game (YES in Step S201). Here, the procedures in Steps S202 to S206 are the same as Steps S171 to S175 in FIG. 12 and detailed explanation of these procedures will therefore be omitted.

On the contrary, when the current unit game is not the rescue setting game (NO in Step S201), the process is terminated without counting the count value Tb (without adding the count value α). Specifically, the count value Tb is not counted in the unit game which is not set as the rescue setting game. In other words, the count value Tb will be counted only in the unit games set as the rescue setting games.

The second embodiment and the modified example thereof have been described according to the example in which the bet made on the unit games are added as the count value a representing the consumed bets, to the count value Tb. Instead, it is also possible to add to the count value, the difference between the bet on the unit games and the payout provided in the unit games. For example, if a total of 30 medals is bet in 10 rounds of the unit games and the payout of 10 medals are qualified by the winning combinations during these 10 rounds of the unit games, it is possible to add 20 medals that represent the difference, to the count value Tb. In this case, the count value Tb is accumulated in response to an actual loss of the pool on the part of the player.

Moreover, the first embodiment has been described according to the example of paying out the rescue pay when the count value Ta of the number of unit games reaches the upper limit value Ta max. Meanwhile, the second embodiment has been described according to the example of paying out the rescue pay when the count value Tb of the bets consumed in the consecutive unit games reaches the upper limit value Tb max. It is also possible to set the payout condition for the rescue pay by combining these examples.

Specifically, it is also possible to cause the payout either when the count value Ta of the number of the unit games reaches the upper limit value Ta max or when the count value Tb of the bets consumed in the consecutive unit games reaches the upper limit value Tb max.

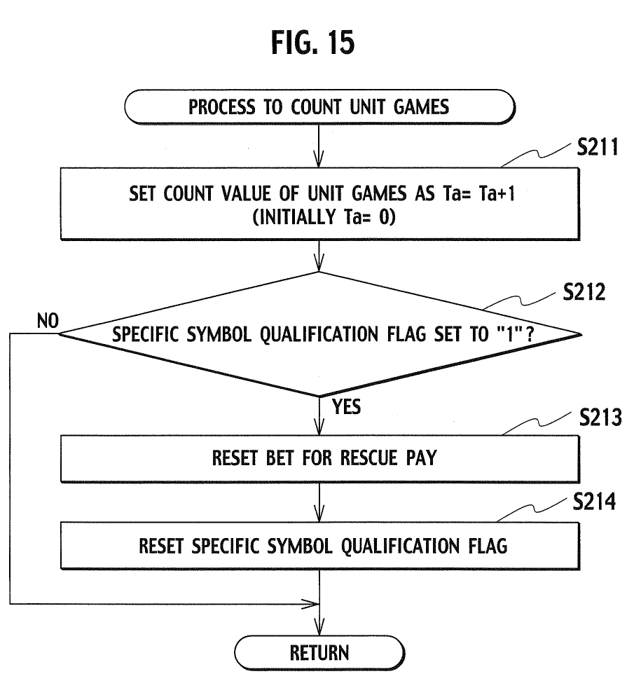

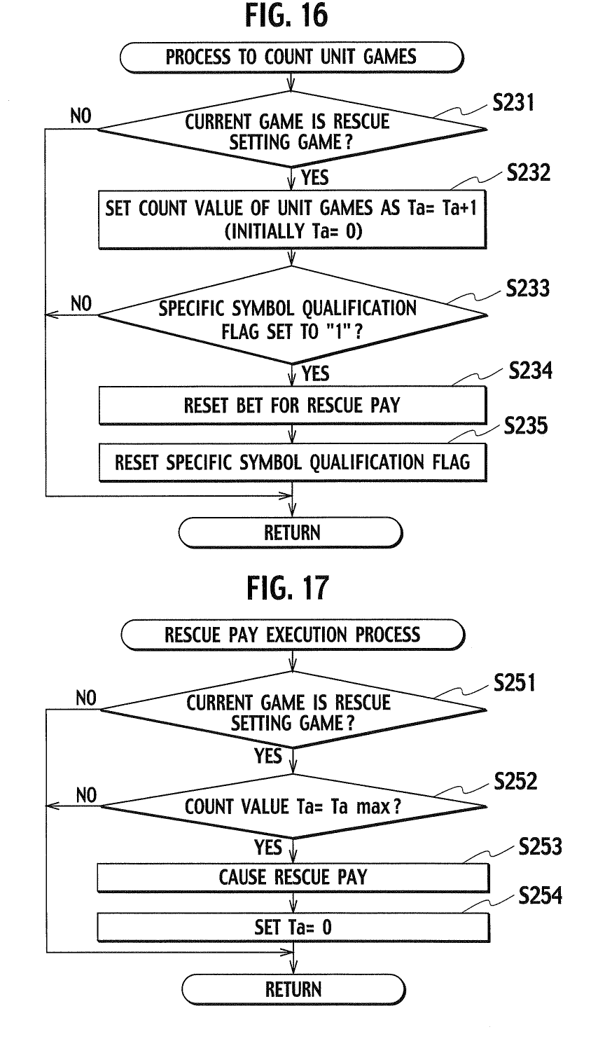

Next, the slot machine 10 serving as the gaming machine according to a third embodiment of the present invention will be described. The unit games executed by the slot machine 10 according to the third embodiment applies different procedures from the first embodiment in terms of the process to count the unit games shown in Step S35 and the rescue pay execution process shown in Step S36 in the flowchart in FIG. 4. Other procedures, namely, the procedures in Steps S31 to S34 and S37 are the same as those in the above-described first embodiment. Now, the process to count the unit games and the rescue pay execution process according to the third embodiment will be described below with reference to flowcharts FIG. 15 and FIG. 17.

First, in the process to count the unit games shown in FIG. 15, the CPU 106 increments the count value Ta of the unit games in Step S211. That is, Ta=Ta+1 is set. Here, the count value Ta is a measured value of the rounds of the executed unit games which is initially set to 0. After finishing this procedure, the process goes to Step S212.

In Step S212, the CPU 106 judges whether or not the specific symbol qualification flag is set to “1”. Specifically, the judgment is made as to whether or not the specific symbol qualification flag shown in Step S76 in FIG. 6 is set to “1”. Here, when the specific symbol qualification flag is set to “1” (YES in Step S212), the CPU 106 resets the bet for the rescue pay in Step S213. Moreover, the CPU 106 resets the specific symbol qualification flag in Step S214. That is, when the player is granted a large benefit equal to or more than 60 credits per credit, the bet for the rescue pay executed in Step S32 in FIG. 4 is reset. This procedure is different from the relevant procedure in the above-described first embodiment in that the count value Ta is not reset herein.

Meanwhile, the process is terminated when the judgment is made in the judgment process in Step S212 that the specific symbol qualification flag is not set to “1”. Specifically, when the specific symbol qualification flag is not set to “1”, the next unit game takes place while incrementing the count value Ta. Then this process is terminated.

Next, procedures of the rescue pay execution process according to the third embodiment will be described with reference to the flowchart FIG. 17. First, in Step S251, the CPU 106 judges whether or not the current unit game is the rescue setting game. Specifically, in the process shown in Step 55 in FIG. 5, the judgment is made as to whether or not the current unit game is the unit game set as the rescue setting game. Here, the process goes to Step S252 when the current unit game is the rescue setting game or the process is terminated when the current unit game is not the rescue setting game.

In Step S252, the CPU 106 judges whether or not the count value Ta of the unit games is equal to the preset upper limit value (the predetermined value) Ta max (Ta max=1000, for example). Here, the process goes to Step S253 when Ta is equal to Ta max or the process is terminated when Ta is not equal to Ta max.

In Step S253, the CPU 106 carries out the process to cause the rescue pay. Specifically, if the specific symbols are not qualified consecutively in the number equivalent to the upper limit value Ta max, or to be precise, if the winning combination qualifying the payout equal to or more than 60 credits per credit does not occur consecutively, then the predetermined rescue pay (such as the payout equivalent to 360 coins) becomes effective. Thereafter, the process goes to Step S254. The count value Ta is reset in Step S254. Thereafter, the process is terminated.

As described above, in the slot machine 10 serving as the gaming machine according to the third embodiment, the bet for the rescue pay is reset when the payout equal to or more than 60 credits per credit is qualified by execution of the unit game, i.e. when the specific symbol qualification flag is set to “1”. Nevertheless, the count value Ta is not reset in this case. Then, the count value Ta is reset after the rescue pay is effected (Step S254 in FIG. 17).

For this reason, the count value Ta is not reset even when the specific symbol qualification flag is set to “1” before the count Ta reaches the upper limit value Ta max. Accordingly, the payout attributable to the rescue pay will be paid out when the count value Ta reaches the upper limit value Ta max provided that the player makes another bet for the rescue pay.

Next, a modified example of the third embodiment will be described. FIG. 16 is a flowchart showing the process to count the unit games according to the modified example of the third embodiment. First, in Step S231, the CPU 106 judges whether or not the current unit game is the rescue setting game. Specifically, the judgment is made as to whether or not the current unit game is the unit game set as the rescue setting game in the procedure in Step S55 in FIG. 5. Then, the process goes to Step S232 when the current game is set as the rescue setting game (YES in Step S231). Here, the procedures in Steps S232 to S235 are the same as Steps S211 to S214 in FIG. 15 and detailed explanation of these procedures will therefore be omitted.

On the contrary, when the current unit game is not the rescue setting game (NO in Step S231), the process is terminated without incrementing the count value Ta. Specifically, the count value Ta is not incremented in the unit game which is not set as the rescue setting game. In other words, the count value Ta will be incremented only in the unit games set as the rescue setting games.

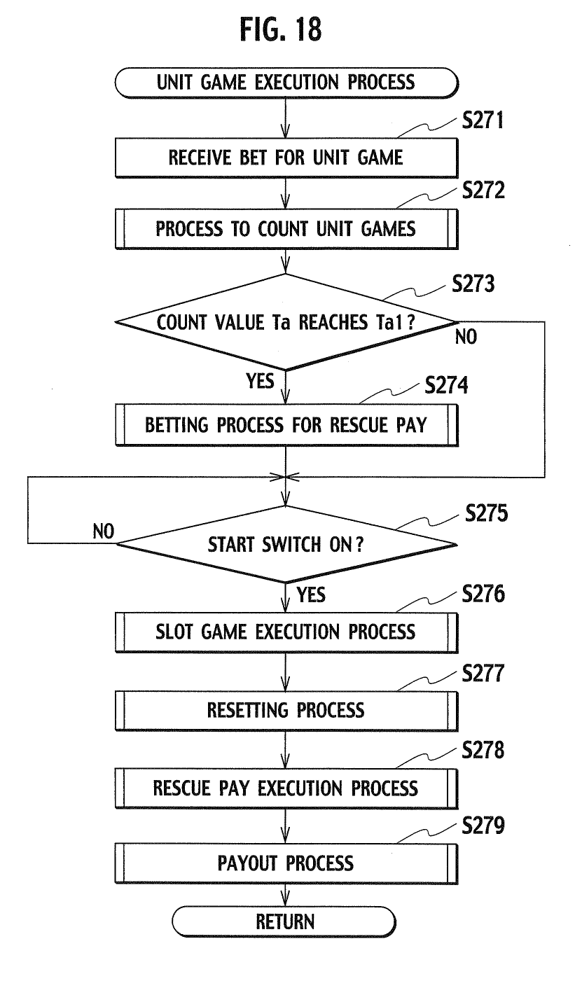

Next, the slot machine 10 serving as the gaming machine according to a fourth embodiment of the present invention will be described. FIG. 18 is a flowchart showing procedures of the unit game execution process with the slot machine according to the fourth embodiment. First, when the unit game is executed, the CPU 106 receives a bet in Step S271. To be more precise, when the medals are inserted from the medal insertion slot 21 or when the credits are bet by means of pressing the MAXBET switch 24 or the BET switch 25, these operations are detected by the CPU 106.

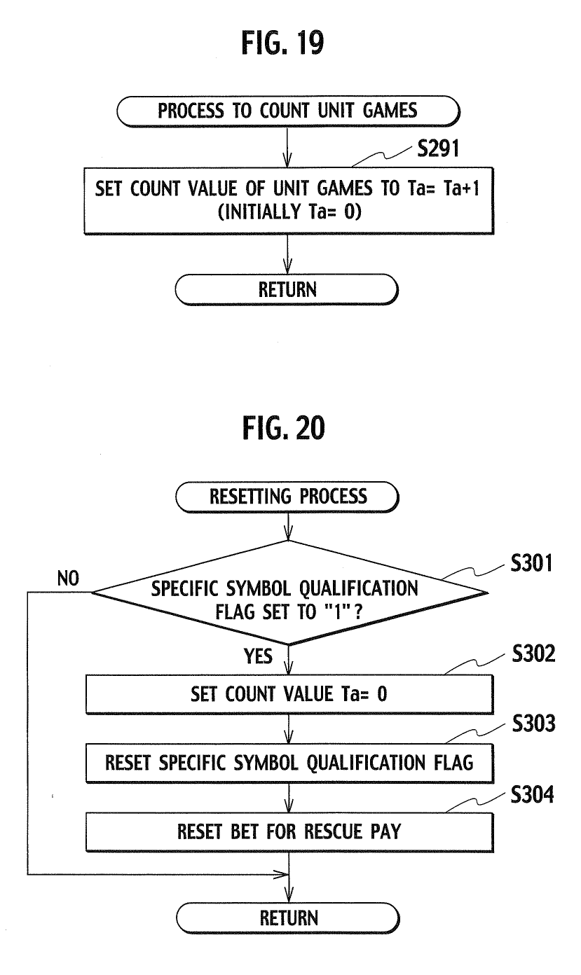

Subsequently, the process to count the unit games is carried out in Step 272. This process to count the unit games will be described later by using a flowchart shown in FIG. 19. Thereafter, in Step S273, the CPU 106 judges whether or not the count value Ta counted in the process to count the unit games reaches a preset reference value Ta1 (Ta1=100, for example). Then, the process goes to Step S274 when the count value Ta reaches the reference value Ta1. On the other hand, the process goes to Step S275 when the count value does not reach the reference value Ta1.

In Step S274, the CPU 106 carries out the betting process for the rescue pay. In this process, the CPU 106 accepts the bet for the rescue pay by using the touch panel sensor 19 provided on the lower liquid crystal display 16. That is, it is possible to bet for the rescue pay only when the count value Ta reaches the reference value Ta1. Here, detailed procedures of the betting process for the rescue pay are the same as the above-described process shown in the flowchart in FIG. 5, and the explanation will therefore be omitted herein.

Thereafter, in Step S275, the CPU 106 judges whether or not the start switch 27 is turned on. The procedure goes to Step S276 when the start switch 27 is turned on.

In Step S276, the CPU 106 carries out the execution process of the slot game. In this process, the CPU 106 executes the process for rearranging the symbols located in the three display regions Q1 to Q3. Detailed procedures are the same as the above-described process shown in FIG. 6, and the explanation will therefore be omitted herein.

In Step S277, the CPU 106 carries out a resetting process. Detailed procedures will be described later with reference to a flowchart show in FIG. 20.

In Step S278, the CPU 106 carries out the rescue pay execution process. In this process, the payout equivalent to the predetermined amount of medals is paid out when no unit games qualifying the preset amount of payout (such as 60 or more medals) occur within the predetermined number of the unit games. Detailed procedures are the same as the above-described process shown in FIG. 8, and the explanation will therefore be omitted herein.

In Step S279, the CPU 106 carries out the payout process. In this process, the payout (such as medals or credits) is provided either when the symbols qualifying the winning combinations stop in the three display regions Q1 to Q3 or when the rescue pay is granted. Thereafter, the process goes to the next unit game.

Next, the process to count the unit games shown in Step S272 in FIG. 18 will be described with reference to the flowchart shown in FIG. 19. In this process, the count value Ta of the unit games is incremented as shown in Step S291 in FIG. 19. Then the process is terminated.

Next, the resetting process shown in Step S277 in FIG. 18 will be described with reference to the flowchart shown in FIG. 20. First, in Step S301, the CPU 106 judges whether or not the specific symbol qualification flag is set to “1”. Specifically, the judgment is made as to whether or not the specific symbol qualification flag is set to “1” in the above-described process shown in Step S76 in FIG. 6. Here, when the specific symbol qualification flag is set to “1” (YES in Step S301), the count value Ta is reset in Step S302. Moreover, the specific symbol qualification flag is reset in Step S303 and the bet for the rescue pay is reset in Step S304.

In other words, when the player is granted a large benefit equal to or more than 60 credits per credit, the count value Ta of the unit games is reset and the bet for the rescue pay executed in Step S274 in FIG. 18 is also reset.

Meanwhile, the process is terminated when the judgment is made in the judgment process in Step S301 that the specific symbol qualification flag is not set to “1” (NO in Step S301). Specifically, when the specific symbol qualification flag is not set to “1”, the next unit game takes place while not resetting the count value Ta, the specific symbol qualification flag or the bet for the rescue pay. Then this process is terminated.

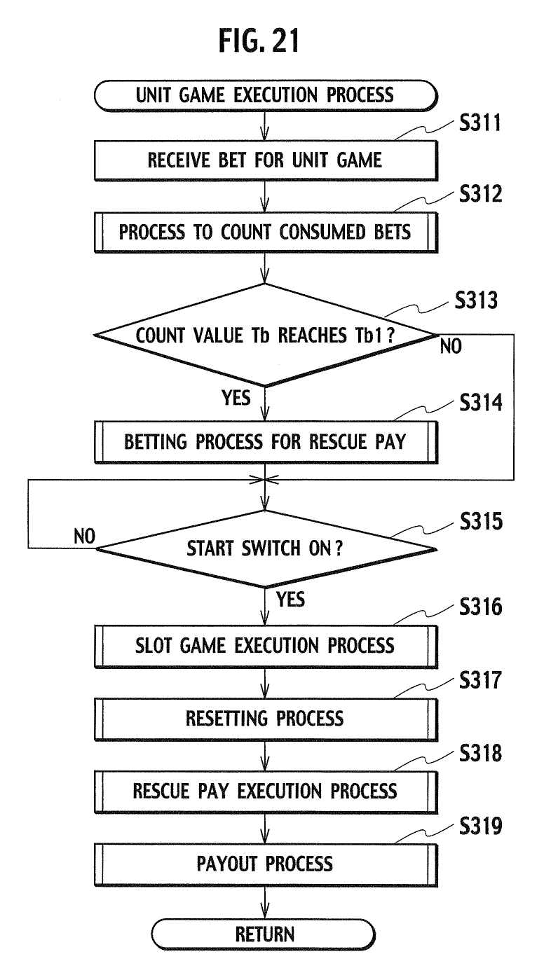

Next, the slot machine 10 serving as the gaming machine according to a fifth embodiment of the present invention will be described. FIG. 21 is a flowchart showing procedures of the unit game execution process with the slot machine according to the fifth embodiment. First, when the unit game is executed, the CPU 106 receives a bet in Step S311. To be more precise, when the medals are inserted from the medal insertion slot 21 or when the credits are bet by means of pressing the MAXBET switch 24 or the BET switch 25, these operations are detected by the CPU 106.

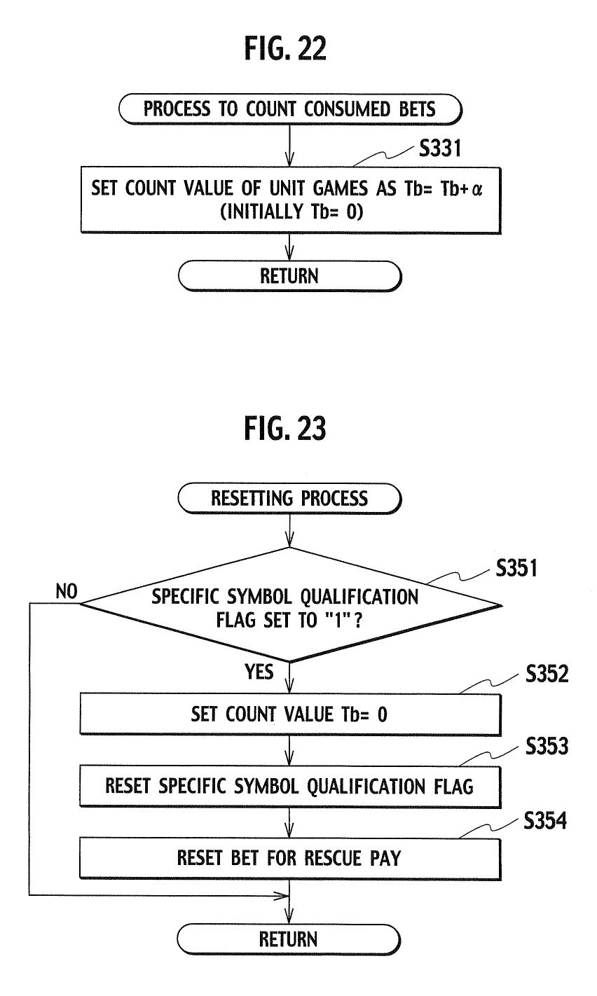

Subsequently, the process to count the consumed pool is carried out in Step 312. This process to count the consumed bets will be described later by using a flowchart shown in FIG. 22. Thereafter, in Step S313, the CPU 106 judges whether or not the count value Tb counted in the process to count the consumed bets reaches a preset reference value Tb1 (Tb1=300, for example). Then, the process goes to Step S314 when the count value Tb reaches the reference value Tb1. On the other hand, the process goes to Step S315 when the count value does not reach the reference value Tb1.

In Step S314, the CPU 106 carries out the betting process for the rescue pay. In this process, the CPU 106 accepts the bet for the rescue pay by using the touch panel sensor 19 provided on the lower liquid crystal display 16. That is, it is possible to bet for the rescue pay only when the count value Tb reaches the reference value Tb1. Here, detailed procedures of the betting process for the rescue pay are the same as the above-described process shown in the flowchart in FIG. 5, and the explanation will therefore be omitted herein.

Thereafter, in Step S315, the CPU 106 judges whether or not the start switch 27 is turned on. The procedure goes to Step S316 when the start switch 27 is turned on.

In Step S316, the CPU 106 carries out the execution process of the slot game. Detailed procedures are the same as the above-described process shown in FIG. 6, and the explanation will therefore be omitted herein.

In Step S317, the CPU 106 carries out the resetting process. Detailed procedures will be described later with reference to a flowchart show in FIG. 23.

In Step S318, the CPU 106 carries out the rescue pay execution process. In this process, the payout equivalent to the preset amount of medals is paid out when no unit games qualifying the predetermined amount of payout (such as 60 or more medals) occur within the predetermined number of the unit games. Detailed procedures are the same as the above-described process shown in FIG. 8, and the explanation will therefore be omitted herein.

In Step S319, the CPU 106 carries out the payout process. In this process, the payout (such as medals or credits) is provided either when the symbols qualifying the winning combinations stop in the three display regions Q1 to Q3 or when the rescue pay is granted. Thereafter, the process goes to the next unit game.

Next, the process to count the consumed bets shown in Step S312 in FIG. 21 will be described with reference to the flowchart shown in FIG. 22. In this process, the count value a corresponding to the bet made on the unit game is added to the count value Tb as shown in Step S331 in FIG. 22. Then the process is terminated.

Next, the resetting process shown in Step S317 in FIG. 21 will be described with reference to the flowchart shown in FIG. 23. First, in Step S351, the CPU 106 judges whether or not the specific symbol qualification flag is set to “1”. Specifically, the judgment is made as to whether or not the specific symbol qualification flag is set to “1” in the above-described process shown in Step S76 in FIG. 6. Here, when the specific symbol qualification flag is set to “1” (YES in Step S351), the count value Tb is reset in Step S352. Moreover, the specific symbol qualification flag is reset in Step S353 and the pool for the rescue pay is reset in Step S354.

That is, when the player is granted a large benefit equal to or more than 60 credits per credit, the count value Tb of the consumed bets is reset and the bet for the rescue pay executed in Step S314 in FIG. 21 is also reset.

Meanwhile, the process is terminated when the judgment is made in the judgment process in Step S351 that the specific symbol qualification flag is not set to “1” (NO in Step S351). Specifically, when the specific symbol qualification flag is not set to “1”, the next unit game takes place without resetting the count value Tb, the specific symbol qualification flag or the bet for the rescue pay. Then this process is terminated.

Although the gaming machine and the method of playing games using the gaming machine of the present invention have been described with reference to certain illustrative embodiments, it is to be understood that the present invention is not limited only to these embodiments and that the configurations of the respective constituents may be replaced by other arbitrary configuration having similar functions thereto.

For instance, the embodiments have described the example of providing the lower liquid crystal display 16 with three pieces of the display regions Q1 to Q3 and executing the slot games by use of these display regions Q1 to Q3. However, the present invention is not limited only to this configuration. The present invention is also applicable to a variety of display regions including display regions in a matrix of 3 rows by 5 columns, for example.

Moreover, the embodiments have applied the configuration to select an arbitrary option by allowing the player to touch the touch panel sensor. However, it is also possible to select an arbitrary option by a switching operation instead of using the touch panel sensor 19.

Further, the slot machine 10 described in the embodiments has been explained based on the example of displaying the symbol images on the lower liquid crystal display 16 to execute the slot games. However, the present invention is not limited only to this configuration and the slot machine 10 may be configured to execute the slot games by rotating multiple drums provided with symbols that are printed on respective circumferences.

In addition, the present invention has been described on the slot machine 10 as a typical gaming machine. However, the present invention is not limited only to this configuration. The present invention is also applicable to other gaming machines such as horse racing games.

What is claimed is:

1. A method of playing games using a gaming machine in which a player can make a bet as a prerequisite for getting an insurance-pay for every predetermined number of unit games, comprising:
making a bet on the unit games;
providing a predetermined amount of award when a play result of the unit game satisfies a specific play result;
making a bet as a prerequisite for getting an insurance-pay on an arbitrary number of the unit games set as a group;
incrementing a count value, which is to be reset under a predetermined resetting condition, every time the unit game is executed; and
providing a predetermined amount of award when the count value reaches a predetermined value in the group of unit games on each of which the bet as a prerequisite for getting the insurance-pay is made.

2. The method of playing games using a gaming machine according to claim 1, wherein the count value is any of the number of the unit games that have been executed, an accumulated amount of bets, made on a plurality of the unit games, and an accumulated value of differences between the amount of bets on the plurality of unit games and an amount of awards.

3. The method of playing games using a gaming machine according to claim 1, wherein the prerequisite for resetting is an occurrence of the specific play result in the unit game.

4. A method of playing games using a gaming machine in which a player can make a bet, as a prerequisite for getting an insurance-pay, for every predetermined number of unit games, comprising:
making a bet on the unit games;
providing a predetermined amount of award when a play result of the unit game satisfies a specific play result;
making a bet as a prerequisite for getting an insurance-pay on an arbitrary number of unit games set as a group;
incrementing a count value to be reset under a predetermined resetting condition with every execution of the unit game on which the bet as a prerequisite for getting the insurance-pay is made; and
providing a predetermined amount of award when the count value reaches a predetermined value in the group of unit games on each of which the bet as a prerequisite for getting the insurance-pay is made.

5. The method of playing games using a gaming machine according to claim 4, wherein the count value is any of the number of the unit games that have been executed, an accumulated amount of bets for a plurality of the unit games, and an accumulated value of differences between the amount of bets for the plurality of the unit games and an amount of awards.

6. The method of playing games using a gaming machine according to claim 4, wherein the prerequisite for resetting is an occurrence of the specific play result in the unit game.

7. A method of playing games using a gaming machine in which a player can make a bet as a prerequisite for getting an insurance-pay for every predetermined number of unit games, comprising:
making a bet on the unit games;
providing a predetermined amount of award when a play result of the unit game satisfies a specific play result;
making a bet as a prerequisite for getting an insurance-pay on an arbitrary number of unit games set as a group;
incrementing a count value, which is to be reset under a predetermined resetting condition, every time the unit game is executed; and
paying out any of medals and coins corresponding to a predetermined amount of bets when the count value reaches a predetermined value in the group of unit games on each of which the bet as a prerequisite for getting the insurance-pay is made.

8. The method of playing games using a gaming machine according to claim 7, wherein the count value is any of the number of the unit games that have been executed, an accumulated amount of bets for a plurality of the unit games, and an accumulated value of differences between the amount of bets for the plurality of unit games and an amount of awards.

9. The method of playing games using a gaming machine according to claim 7, wherein the prerequisite for resetting is an occurrence of the specific play result in the unit game.

10. A gaming machine in which a player can make a bet as a prerequisite for getting an insurance-pay for every predetermined number of unit games, comprising:
a display configured to display an image concerning a unit game for determining whether or not a play result deserves an award;
a counter configured to be reset under a predetermined resetting condition and to increment a count value every time the unit game is executed; and
a controller operable to:
(a) provide a predetermined amount of award when a play result of the unit game satisfies a specific play result;
(b) receive a bet, as a prerequisite for getting an insurance-pay, made on an arbitrary number of unit games set as a group; and
(c) provide a predetermined amount of award when the count value reaches a predetermined value in the group of unit games on each of which the bet as a prerequisite for getting the insurance-pay is made.

11. The gaming machine according to claim 10, wherein the count value counted by the counter is any of the number of the unit games that have been executed, an accumulated amount of bets for a plurality of the unit games, and an accumulated value of differences between the amount of bets for the plurality of the unit games and an amount of awards.

12. The gaming machine according to claim 10, wherein the prerequisite for resetting is an occurrence of the specific play result in the unit game.

13. A gaming machine in which a player can make a bet as a prerequisite for getting an insurance-pay for every predetermined number of unit games, comprising:
a display configured to display an image concerning a unit game for determining whether or not a play result deserves an award;
a counter configured to be reset under a predetermined resetting condition and to increment a count value with every execution of the unit game on which a bet as a prerequisite for getting an insurance-pay is made; and
a controller operable to:
(a) provide a predetermined amount of award when a play result of the unit game satisfies a specific play result;
(b) receive a bet, as a prerequisite for getting the insurance-pay, made on an arbitrary number of the unit games set as a group; and
(c) provide a predetermined amount of award when the count value reaches a predetermined value in the group of unit games on each of which the bet as a prerequisite for getting the insurance-pay is made.

14. The gaming machine according to claim 13, wherein the count value counted by the counter is any of the number of the unit games that have been executed, an accumulated amount of bets for a plurality of the unit games, and an accumulated value of differences between the amount of bets for the plurality of the unit games and an amount of awards.

15. The gaming machine according to claim 13, wherein the prerequisite for resetting is an occurrence of the specific play result in the unit game.

16. A gaming machine in which a player can make a bet as a prerequisite for getting an insurance-pay for every predetermined number of unit games, comprising:
a display configured to display an image concerning a unit game for determining whether or not a play result deserves an award;
a counter configured to be reset under a predetermined resetting condition and to increment a count value every time the unit game is executed; and
a controller operable to:
(a) provide a predetermined amount of award when a play result of the unit game satisfies a specific play result;
(b) receive a bet, as a prerequisite for getting an insurance-pay, made on an arbitrary number of the unit games set as a group, and
(c) pay out any of medals and coins corresponding to a predetermined amount of bets when the count value reaches a predetermined value in the group of unit games on each of which the bet as a prerequisite for getting the insurance-pay is made.

17. The gaming machine according to claim 16, wherein the count value counted by the counter is any of the number of the unit games that have been executed, an accumulated amount of bets for a plurality of the unit games, and an accumulated value of differences between the amount of bets for the plurality of the unit games and an amount of awards.

18. The gaming machine according to claim 16, wherein the prerequisite for resetting is an occurrence of the specific play result in the unit game.
